(19) United States
(12) Patent Application Publication
(10) Pub. No.: US 2013/0346874 A1
(43) Pub. Date: Dec. 26, 2013

(54) User configurable electronic textbook

(71) Applicant: Keys to Medicine, LLC, Tallahassee, FL (US)

(72) Inventor: Kenneth A. Wallace, Windermere, FL (US)

(73) Assignee: Keys to Medicine, LLC, Tallahassee, FL (US)

(21) Appl. No.: 13/986,069

(22) Filed: Mar. 28, 2013

Related U.S. Application Data
(60) Provisional application No. 61/686,117, filed on Mar. 30, 2012.

(51) Int. Cl. G06F 17/30

(52) U.S. Cl. CPC G06F 17/30011
USPC 715/744

(57) ABSTRACT

An on-line system is disclosed for enabling and maintaining a plurality of separate user specific versions of a user configurable electronic textbook. The textbook includes a template stored in a master database table and an associated user specific database table for storing personalized subject matter. The template may include certain images and textual content as well as subject matter organizational outline. The system allows a user to upload images to the system under a specific heading of the organizational outline in the template. The images can be annotated and stored in a user specific database. The user specific database is not accessible to other users of the on-line system. Thus, users may create a personalized electronic textbook. In one embodiment of the invention, the administrator can upload images from the various users to the master database table so that those images can be made available to other users.

### CROSS REFERENCE TO RELATED APPLICATIONS

This application claims priority to and the benefit of U.S. Provisional Application No. 61/686,117, filed Mar. 30, 2012, hereby incorporated by reference.

### COMPUTER APPENDIX

This application includes a Computer Listing Appendix on compact disc, hereby incorporated by reference.

### BACKGROUND OF THE INVENTION

1. Field of the Invention

The present invention relates to an electronic textbook available by subscription to a plurality of users that enables each user to personalize their electronic textbook while allowing their personalized content to be selectively protected from access by other users and allows the personalized content to be shared with selected users, for example, in a professional or academic group.

2. Description of the Prior Art

Various electronic textbooks are known in the art. Examples of electronic textbooks used in the medical field are disclosed in US Patent Application Publication Nos.: US 2004/007118 A1; US 2005/0065813 A1 and US 2007/0118550. These published patent applications all disclose methods for publishing medical textbooks electronically and are used in teaching and research applications.

US Patent Application Publication No. US2004/0107118 A1 discloses a system and method of gathering, storing and distributing medical information to create an “electronic textbook reference”. The system allows for online access and submission of reference information regarding diagnoses and medical education, such as clinical and pathology photos. A case authoring tool allows entry and editing of images and text relating to case information. Case information includes author and contributor information and link to the pertinent diagnosis name.

Unfortunately, once published, the electronic textbooks disclosed in the '118 publication has limited functionality. In particular, the usefulness of an electronic textbook is generally the same as a paper textbook. More particularly, the system disclosed in the '118 publication does not allow editing of content nor additional content by third party users after the electronic textbook is published. While such a system is useful for creating generic medical textbooks, such medical textbooks are of limited value to practicing physicians since new pathological and clinical patient data cannot be included in such a medical textbook nor shared with selected users or groups.

US Patent Application Publication No. US 2005/0065813 A1 discloses a medical software system that enables evaluation of patients by doctors via the Internet. A reference database compiles reference material that includes photographs. The system is used to upload patient information to an aggregate database. The exportation of the medical information from the system can serve as a research tool and a learning tool for other physicians looking for case studies. Unfortunately, this system does not allow for a personalized database on a physician by physician basis nor allow sharing of medical information.

US Patent Application Publication No. US2007/0118550 A1 discloses a method for creating personal databases. However, the image sources must be extracted from a common database. More specifically, the '550 application discloses a system for retrieving medical images from various sources to enable the creation of teaching files and research datasets for the building of a personal medical image library from the various sources. The medical images may be from the discipline of dermatology. A user interface is provided to access the medical image library stored in a database. Internet based searching mechanisms are provided the database. Because the medical information is shared with a Medical Imaging Resource Center (MIRC), all of the patient specific information is made anonymous to third parties.

Although the system disclosed in the '550 publication allows for the creation of a personal library, for example, of medical images, the medical images are only available to members of MIRC. In other words, only images that are stored in the MIRC database in a special format are available that are stored in the MIRC database are available for creation of a personal library. In particular, it is known that Medical Imaging Resource Center (MIRC) project has a defined a set of protocols and formats to facilitate and standardize the storage, query, and retrieval of radiologic images and related information via the Internet. These protocols and standards are published in various references including Siegel E et al, “The Radiological Society of North America's Medical Image Resource Center: An Update. J Digit Imaging 2001; 14(2 suppl 1): 77-79 and Siege I et al. Medical Image Resource Center 2002: An Update on the RSNA's Medical Image Resource Center. J Digit Imaging 2002; 15(1): 2-4.

Thus, although the system disclosed in the '550 application provides for the creation of a personal library, the personal library can only be created from medical images in a MIRC database that have been submitted by members of MIRC using a specialized format and protocol. Moreover, no editing of images retrieved from the MIRC database can be edited. More specifically, personalized notes cannot be added to the retrieved images nor can personalized notes be added to the physician's own images since the images must follow a specified protocol and format.

Other electronic systems are known for providing computer assisted diagnoses of certain medical issues including dermatological issues. Examples of these systems are disclosed in US Patent Application Publication Nos.: US 2008/0275315 A1; US 2008/0194928 A1; US 2008/0140708 A1; and U.S. Pat. Nos. 6,941,323; 7,233,693; and 7,564,990. These systems all operate on the basis of analyzing an image of a body part and providing a diagnosis. None of these systems allow for the creation of a personalized database.

US Patent Application Publication No. US 2008/0275315 A1 discloses a remote diagnosis system for facilitating the diagnosis of a skin melanoma. A user scans the suspected skin of being melanoma through a dermoscope. The dermoscope is attached to a portable telephone with a camera and Internet access by means of an adapter. The user sends the picked up skin image to the remote diagnosis apparatus over the Internet. After receiving the skin image, the remote diagnosis apparatus uses a melanoma diagnosis program to examine the skin image for melanoma and a disease stage of melanoma if there is melanoma and then sends a result to the user.

US Patent Application Publication No. US 2008/0194928 A1 discloses an imaging device that permits a user to take high magnification pictures of the skin in the vicinity of an area of concern and submit those pictures, optionally along with textual and data responses, for medical, non-medical, and cosmetic analysis, diagnosis and treatment recommendation and follow-up. A user may use a device embodied in a cellular phone to capture an image of the skin and upload it to a mobile platform for analysis to determine a skin state. A user may choose to share the skin state as part of a practitioner record. An algorithm is used to generate searchable and/or indexable tags to associate with images. The images are tagged with information relating to a skin state and a skin condition. The algorithm is used to perform a search using the information associated with the image as a search term. The search may be performed against information or images from other users' or a third party database to identify similarities or differences in images or information.

US Patent Application Publication No. US20080140708 A1 discloses computer-aided medical diagnostic and the transmission of medical information including information such as digital images, mainly skin images, additional patient information and the computer-aided analysis and diagnostic of diseases over the Internet. Medical information transmitted is analyzed by diagnostic software. The main mechanism of analysis is the comparison of the image, coupled with the additional information, with a database of known characteristics of the analyzed disease. Such a database may include images of other patients, a well as historical information of the patient.

U.S. Pat. No. 6,941,323 discloses a computer-aided image comparison, evaluation and retrieval system compares objects and object clusters, or images. A query image may comprise a digital image of an area of skin pigmentation. Other images of skin pigmentation which are stored in an image database are filtered and images of skin pigmentation which are similar are identified. Advantageously, the pigmentation area of the stored images has been previously characterized as being melanoma or not. If retrieved similar object images are predominantly images of melanomas, a physician may be alerted that the possibility of melanoma for the query image is high.

U.S. Pat. No. 7,233,693 discloses methods and systems for digitally evaluating skin conditions based on a skin image. A digital image of a surface of a human face is received from a camera set in an image capturing device. A plurality of kinds of analysis (e.g., evaluation of a skin color, evaluation of pigmented spots, evaluation of pores, and/or evaluation of wrinkles) is performed on the received digital image to produce a plurality of data representing skin conditions of the human body. The produced data are output to a display or a database.

U.S. Pat. No. 7,564,990 discloses a system for capturing and analyzing images of body features to identify treatments. A rating software component receives the pixel image data from the image sensor and is configured to mimic the judgment of a dermatologist to provide a rating vector representing the condition of three or more attributes of the body feature represented by the pixel image data (see abstract). A PDA provides the computer processing needed. A variety of other processor platforms could be used, including handheld messaging and telephone devices.

US Patent Application Publication No. US 2008/0229246 A1 discloses an electronic database for use by plastic surgeons and dermatologists which includes a template for organizing patient data and includes the ability to upload “before” and “after” photographs of the patient into the template. Although the '246 publication allows the creation of personalized files, the files are organized by patient. As such, the system disclosed in the '246 publication does not allow physicians to search their personal files by other than patient names. For example, a physician cannot search his personal files by pathology.

Thus, there is a need for personalized system that allows a user to store data in a textbook template that can be used by the user for research based upon the user's own input data.

### SUMMARY OF THE INVENTION

Briefly, the invention relates to an electronic textbook available by subscription to a plurality of users that enables each user to personalize their electronic textbook while allowing their personalized content to be selectively protected from access by other users and allows the personalized content to be shared with selected users, for example, in a professional or academic group. An on-line system is provided for enabling and maintaining a plurality of separate user specific versions of a user configurable electronic textbook. The textbook includes a template stored in a master database table and may include administrator supplied images and an associated user specific database table for storing personalized subject matter. if desired. The template may include certain images and textual content as well as subject matter organizational outline. The system allows a user to upload images to the system under a specific heading of the organizational outline in the template. The images can be annotated and stored in a user specific database. The user specific database is not accessible to other users of the on-line system. In one embodiment of the invention, the administrator can upload images from the various users to the master database table so that those images can be made available to other users.

### DESCRIPTION OF THE DRAWING

These and other advantages of the present invention will be readily understood with reference to the following specification and attached drawing wherein:

FIG. 1 is a simplified diagram of the user configurable textbook in accordance with the present invention.

FIG. 2 is a simplified data flow diagram of the user configurable textbook in accordance with the present invention.

FIG. 3 is an exemplary home page illustrating a portion of a tree diagram that forms a portion of the present invention.

FIG. 4 is an exemplary web page illustrating a search feature in accordance with the present invention.

FIG. 5 is an exemplary web page illustrating in method for annotating images that forms part of the invention.

FIG. 6A is an exemplary web page illustrating a dashboard for navigating the system in accordance with the present invention.

FIG. 6B is an exemplary web page illustrating a number of dialog boxes for uploading an entry or a page to the system.

FIG. 7 is an exemplary web page illustrating a method for uploading images to the system.

FIG. 8 illustrates one method of uploading images from a user's personal computer.

FIG. 9 illustrates a sample picture uploaded from a user's personal computer onto an image tray in accordance with the present invention.

FIG. 10 illustrates an exemplary method for loading a sample picture onto the system.

FIGS. 11A and 11B illustrate the sample picture being loaded on the system.

FIG. 12 is an exemplary web page illustrating the entry and page buttons on the dashboard.

FIG. 13 is an exemplary web page used for editing entry data in the system.

FIG. 14 is similar to FIG. 13 except it is used for managing page data that has been posted to the website.

FIG. 15A is an exemplary web page allows comments to the images to be approved or deleted by the administrator.

FIG. 15B is an exemplary web page illustrating a number of dialog boxes for posting comments.

FIG. 16 is an exemplary web page that provides a list of tags used in the system.

FIG. 17 is an exemplary web page illustrating the various categories on the tree illustrated in FIG. 3 which allows the addition and editing of the various categories.

FIG. 18-22 are exemplary web pages that are more refined than the web pages illustrated in FIGS. 3-17 illustrating various aspects of the present invention.

FIGS. 23A and 23B are exemplary logic flow charts for the system illustrated in FIGS. 3-17.

FIG. 24 is an exemplary database diagram illustrating data flow for the system illustrated in FIGS. 3-17.

FIGS. 25A -25E are exemplary logic flow charts for an alternative embodiment of the present invention that are relatively more detailed than the logic flow charts illustrated in FIGS. 23A-23B.

FIGS. 26A-26B are simplified diagrams illustrating the logical structure of an alternative database structure for an alternative embodiment of the present invention.

FIGS. 27A and 27B are logic diagrams for an alternative embodiment of the present invention.

FIG. 28 is an exemplary screen shot of an alternate embodiment of the invention illustrating an exemplary medical content tree in a collapsed position.

FIG. 29 is an exemplary screen shot of the alternate embodiment illustrated in FIG. 28, illustrating the medical content tree partially expanded.

FIG. 30 is an exemplary screen shot of an alternate embodiment illustrated in FIG. 28, after an exemplary diagnosis for basal cell carcinoma with follicular differentiation has been selected and a content button has been selected illustrating exemplary text under an exemplary web page entitled “Synonyms/Eponyms” for the exemplary diagnosis, basal cell carcinoma with follicular differentiation.

FIG. 31 is similar to FIG. 30 but for an exemplary “Clinical “webpage illustrating exemplary clinical data for the exemplary diagnosis, basal cell carcinoma with follicular differentiation.

FIG. 32 is similar to FIG. 30 but for an exemplary “Pathology “webpage illustrating for the exemplary diagnosis, basal cell carcinoma with follicular differentiation.

FIG. 33 is similar to FIG. 30 but for an exemplary “Dx/Diagnosis “webpage for the exemplary diagnosis, basal cell carcinoma with follicular differentiation.

FIG. 34 is an exemplary web page for uploading clinical images for a selected diagnosis from the medical content tree.

FIGS. 35-38 are exemplary step by step screen shots illustrating how clinical images are uploaded for a selected diagnosis from the medical content tree.

FIG. 39 is an exemplary screen shot for uploading pathology images and data for a selected diagnosis from the medical content tree.

FIG. 40 is an exemplary screen shot for uploading videos for a selected diagnosis from the medical content tree.

FIG. 41 is an exemplary screen shot for uploading test questions for a selected diagnosis from the medical content tree.

FIG. 42 is an exemplary screen shot illustrating various settings for the various content uploaded.

FIGS. 43a-43d illustrate an expanded version of the medical content tree in response to an exemplary search for basal cell carcinoma being inserted in the search text box illustrating all of the diagnoses matching the search parameters in a different color.

FIG. 44 illustrates an exemplary screen shot illustrating adding a new file to an existing home page.

FIGS. 45A and 45B illustrate an exemplary home pages of an email text box that can be used for sending medical images and data for a selected diagnosis from a user to the administrator and among subscribers.

FIG. 46 is an exemplary view of an attachment to the email illustrating the various content by the originator of the email.

FIG. 47 is an exemplary email that is sent to a recipient.

### DETAILED DESCRIPTION

The present invention relates to an electronic textbook available by subscription to a plurality of users that enables each user to personalize their electronic textbook while allowing their personalized content to be selectively protected from access by other users and allows the personalized content to be shared with selected users, for example, in a professional or academic group. An on-line system is provided for enabling and maintaining a plurality of separate user specific versions of a user configurable electronic textbook. The textbook includes an electronic template stored in a master database table which provides organization for the textbook. The template may include certain images and textual content as well as a subject matter organizational outline. The system allows a user to upload images to the system under a specific heading of the organizational outline in the template. The images can be annotated and stored in a user specific database. The user specific database is not accessible to other users of the on-line system. Thus, users may create a personalized electronic textbook. In one embodiment of the invention, the administrator can upload images from the various users to the master database table so that those images can be made available to other users.

The principles of the present invention are applicable to various types of subject matter. A user configurable electronic textbook for use by dermatologists is illustrated and described herein. However, the principles of the present invention are not so limited. In an embodiment of an electronic medical textbook, the system may be used by various physicians to update the electronic textbook with current medical data from their respective medical practices to personalize their medical textbook. For example, a dermatologist may use the system to record images and personal notes of various dermatological conditions of their patients. In such an embodiment, the images and personal notes may be stored according to the subject matter of the textbook to which they are associated. The images can be annotated, for example, with various medical data, such as the patient's response to various treatments. The images and annotations can be stored, for example, by diagnosis.

In accordance with another important aspect of the invention, the database as well as the electronic text book may be accessible over the Internet, for example, by way of an Internet enabled cellular phone. In such an embodiment, the system allows dermatologists or other users to photograph or provide images of certain dermatological conditions of their own patients by way of an internet enabled cellular phone with an integral camera, such as an iPhone or other phone, and upload those photos into a selected category corresponding to a diagnosis category, thus personalizing their textbook.

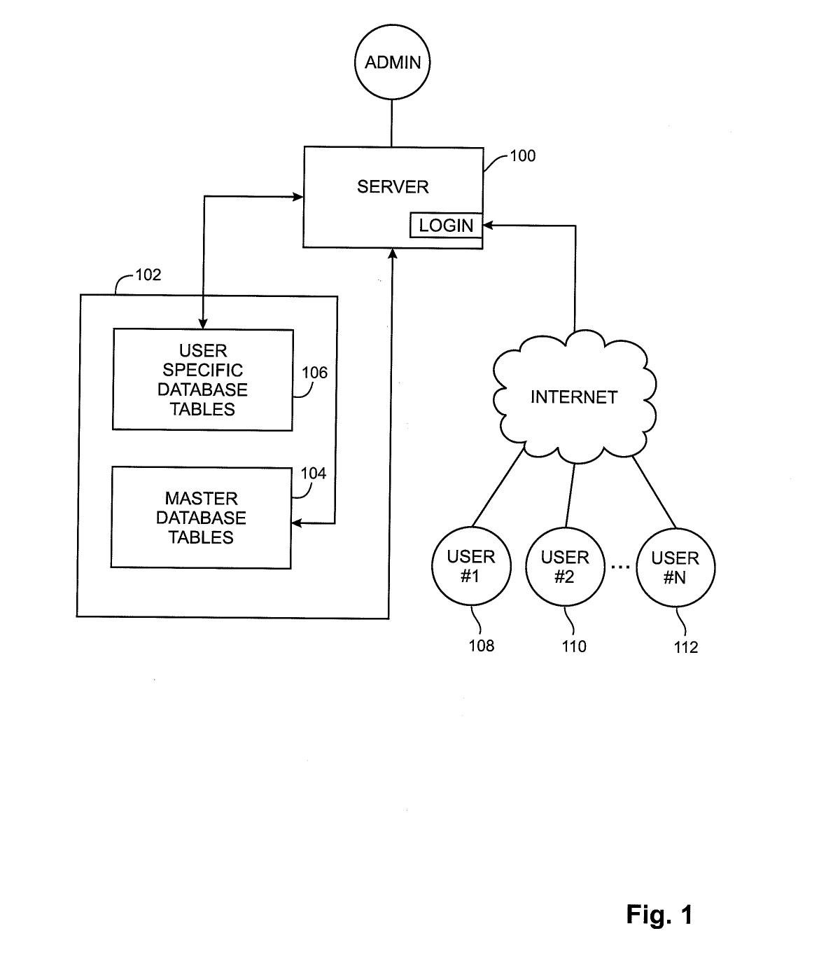

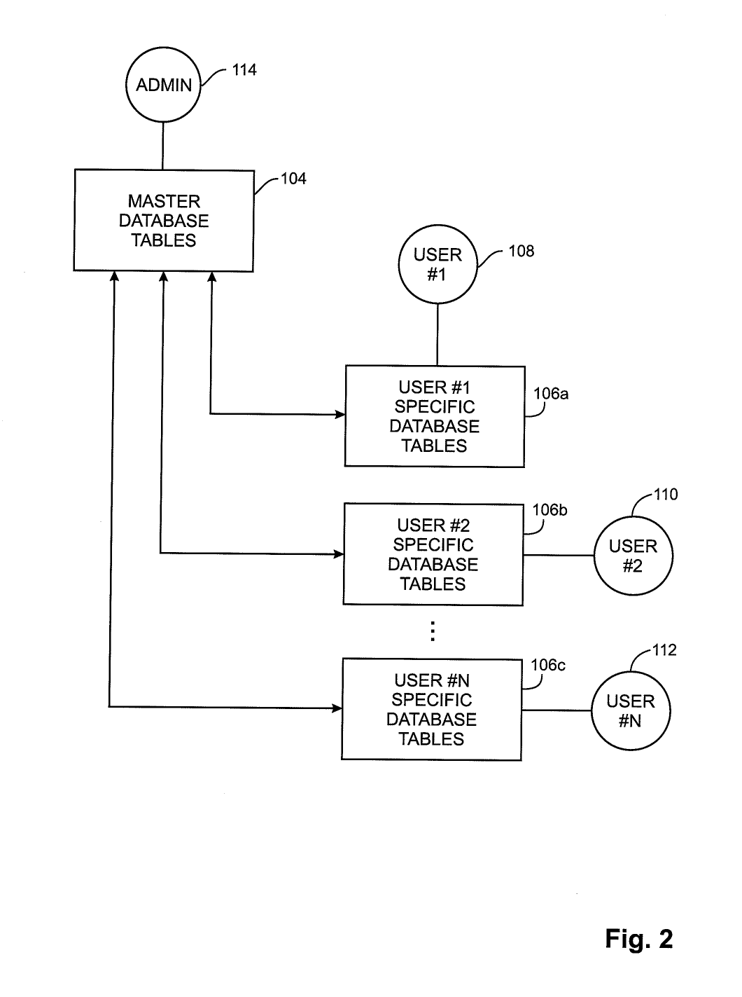

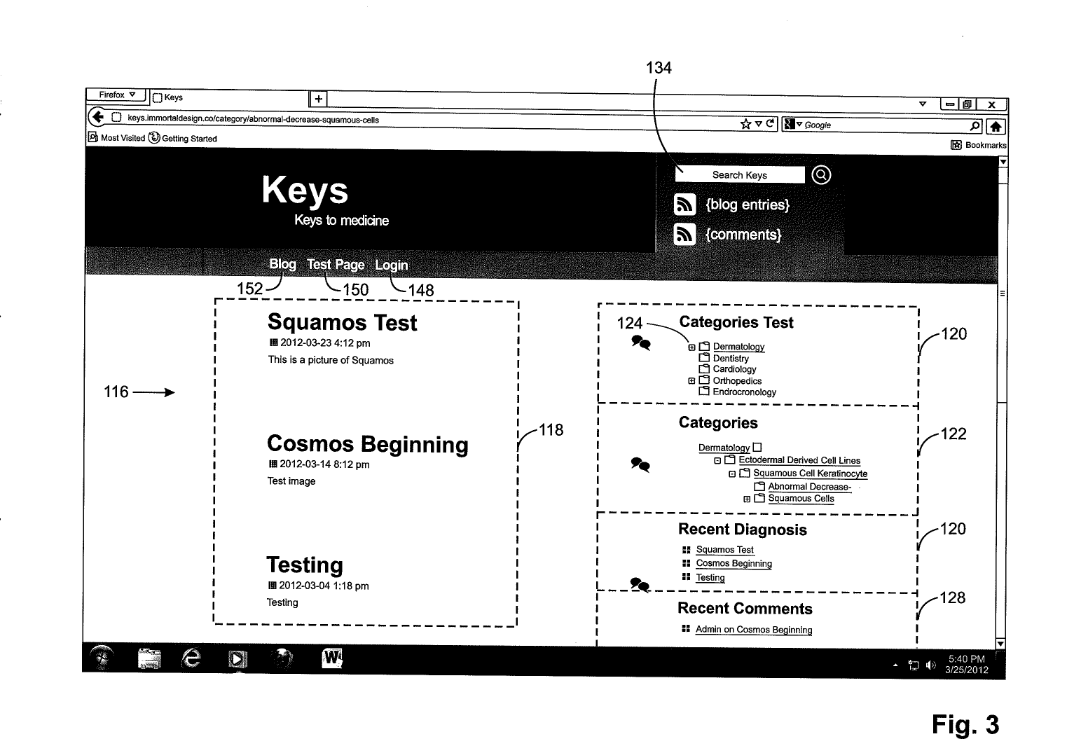

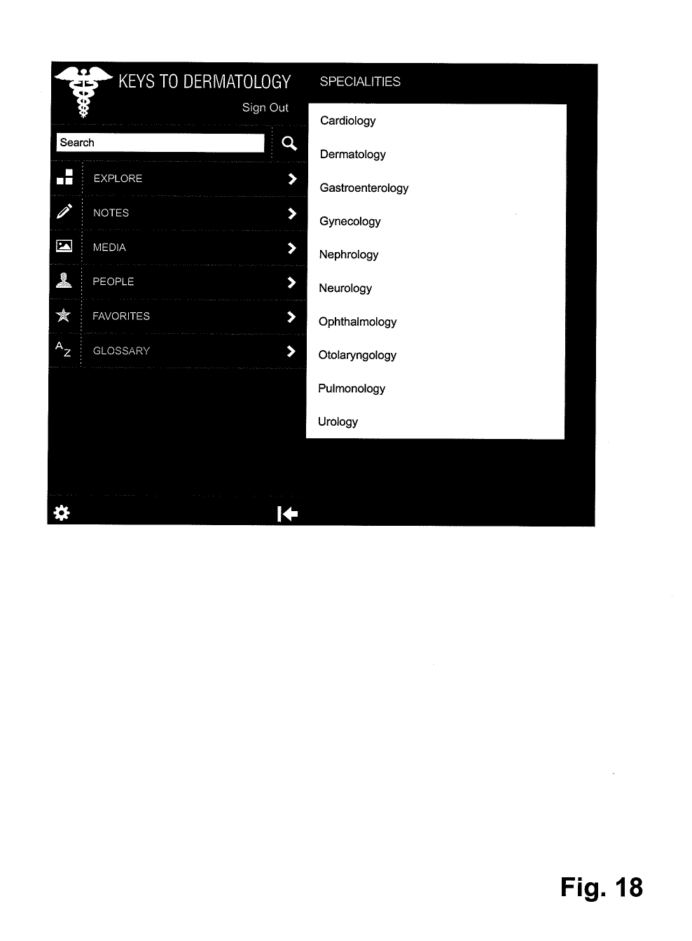

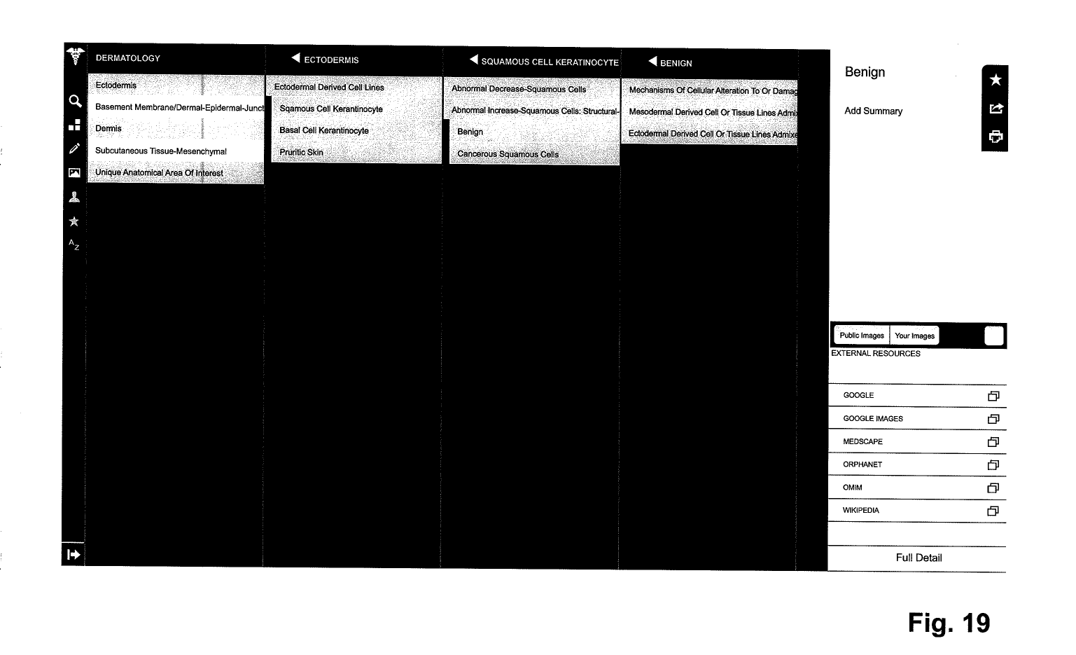

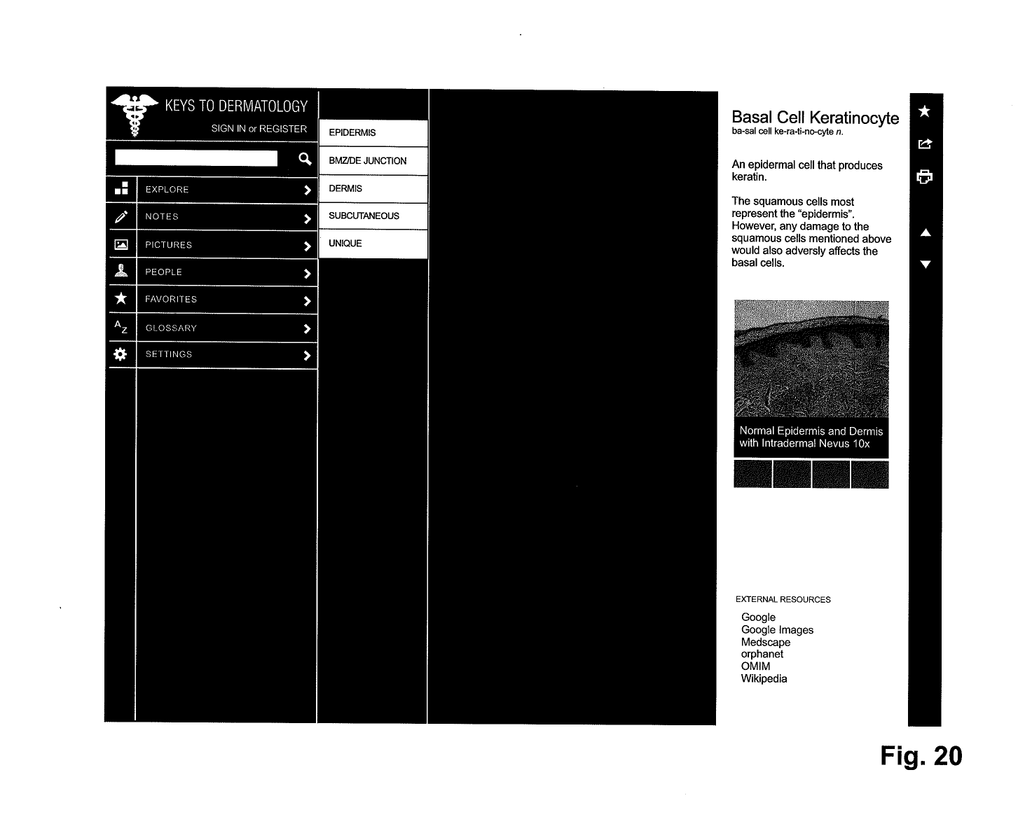

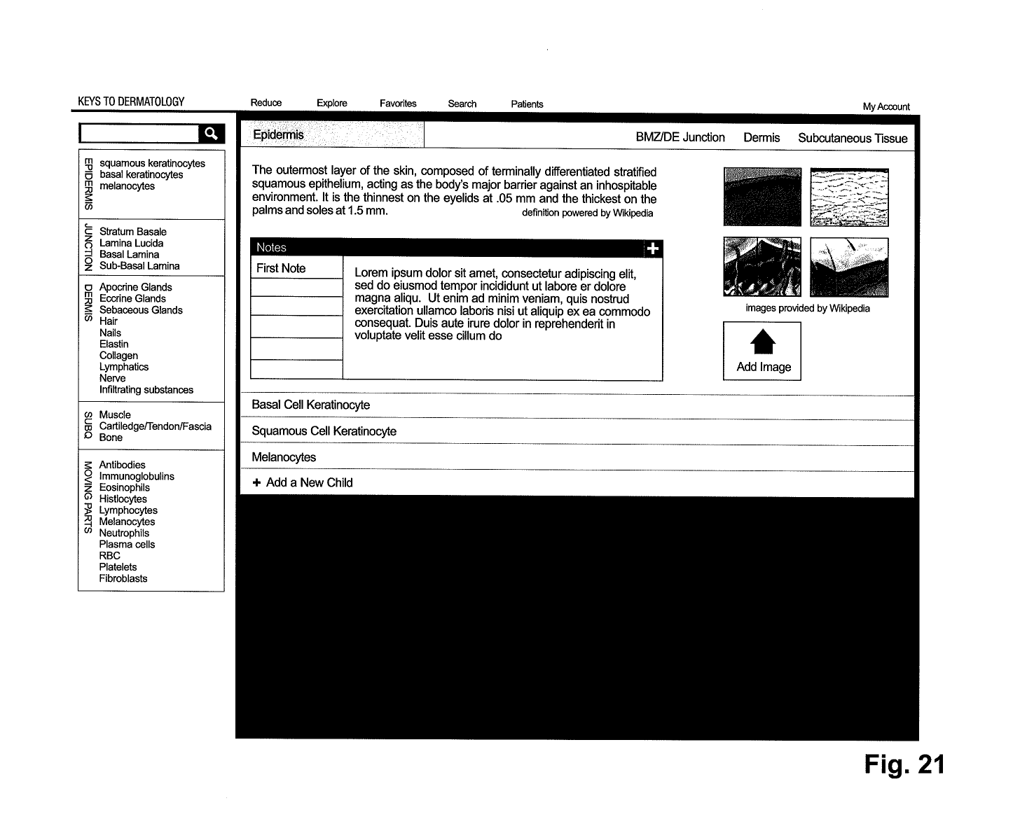

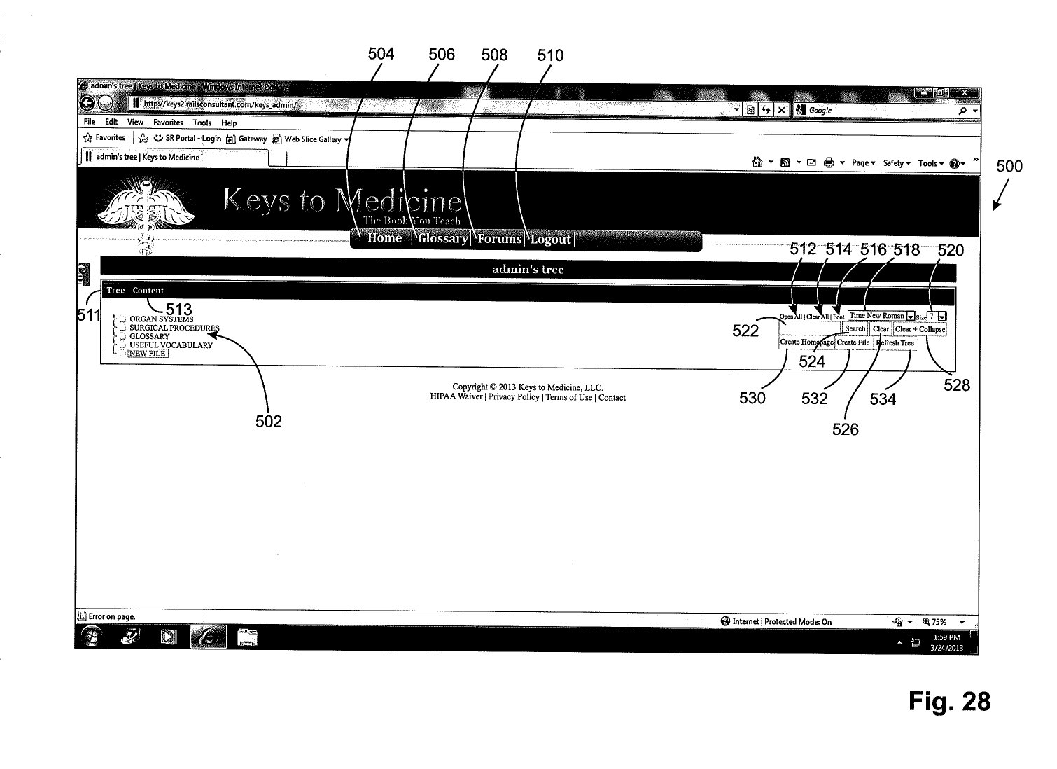

FIGS. 1 and 2 provide a general overview of the invention. FIGS. 3-17, 23 and 24 illustrate one embodiment of the invention. FIGS. 18-22, 25A-27B relate to a second embodiment of the invention. FIG. 28—illustrate an alternate third embodiment of the invention.

### System Overview

An overview of the system is provided in FIG. 1. As shown, the system includes a central server 100. The server 100 is in communication with one or more databases, identified with the reference numeral 102. The one or more databases 102 are partitioned into Master Database Tables 104 and User Specific Database Tables 106. As mentioned above, the Master Database Tables 104 may include a template that may include certain images and textual content as well as a subject matter organizational outline. The User Specific Database Tables 106 includes user specific information. This user specific information may include images as well as text that is tagged to specific topics or objects on the subject matter organizational outline. In addition, users can annotate images included from the Master Database tables 104 which are stored in the User Specific Database Tables 106.

In accordance with one aspect of the invention, a plurality of users 108, 110 and 112 may log-in and be connected to the server 100 by way of a wired or wireless communication network. The wireless communication network may be a public cellular network. Alternatively, the users 108, 110 and 112 can be connected to the server 100 by way of the Internet over a wired or wireless communication network. In one aspect of the invention, users 108, 110 and 112 that are equipped with smart phones and integral cameras, such as an iPhone, can send images and content to the server 100 directly thus facilitating the personalization of the electronic textbook.

As shown in FIG. 2, each user 108, 110 and 112 has read and write access to only their user specific database table 106a, 106b and 106c, respectively. In other words user 108 will only have read and write access to User Specific Database Table 106a. User 110 will only have read and write access to User Specific Database Table 106b. Similarly, user 112 will only have read and write access to User Specific Database Table 106c. All users 106a, 106b and 106c have read only access to the Master Database Tables 104. An administrator 114 is the only one with read and write access to the Master Database Tables 104.

In addition, each user 108, 110 and 112 will have the option of making individual files in their User Specific Database Tables either public or private. If the user opts to keep the file private, the file will be stored in the User Specific Database Tables 106 and only the user that created the file will have access. Alternatively, if the user opts to make the file public, the administrator will have access to the file and can decide whether to add the content to the Master Database Tables.

The administrator 114 may also have read access to the User Specific Database Tables 106a, 106b and 106c. There are several reasons for providing the Administrator 114 such access. First, the Administrator 114 may need screen inappropriate content on the User Specific Databases 106a, 106b and 106c. Second, the Administrator 114 may need to correct incorrect content and misplaced images in the template.

The invention may be implemented as a web-based invention. Various conventional web browsers, such as Internet Explorer and Mozilla Firefox, are suitable for use with the present invention.

### First Embodiment of the Invention

As mentioned above, the system may be web based and configured as a web portal. An exemplary home page is illustrated in FIG. 3 and generally identified with the reference numeral 116. Access to the home page 116 would require each user 108, 110 and 112 to log-in. A user's log-in information identifies the user 108, 110 and 112 to the system and provides the user with read access to the Master Data Tables 104 and read/write access to the user's respective Use Specific Database Table 106a, 106b and 106c.

Referring to FIG. 3, the exemplary home web page 116 has various component parts. The various component parts are shown in dotted boxes. Each of the component parts illustrated is simply for discussion. More or fewer component parts may be included and still be within the spirit and scope of the invention. FIGS. 3-16 illustrate a user configurable electronic medical textbook. The dotted box 118 may include the most recent additions to the user's respective User Specific Data Base Tables 106a (FIG. 2), 106b and 106c. The dotted boxes 120 and 122, captioned “Categories Test” and “Categories” are drop down menus illustrating the subject matter of the electronic textbook. The dotted box 122, identified as “Categories Test” provides an exemplary subject matter template. In this example, subject matter template refers to medical specialties. As shown in the dotted box, a partial list of medical specialties is shown. FIG. 18 illustrates a more complete list of medical specialties. The dotted box 122 is a subset of the subject matter template in box 120. More specifically, when a particular subject matter is selected in box 120, a subset of that subject matter is displayed in box 122. In other words in the illustrative example shown in FIG. 3, assume the box labeled “Dermatology” in box 120 is selected. If the drop down menu button 124 is selected, a hierarchal tree diagram is displayed. Each level of the tree diagram may represent a specific diagnosis.

The tree diagram provides an outline and template of various categories in medicine. Each line of the tree diagram may have its own drop down menu button to allow the user to display another level of the tree. The drop down menu buttons can also be used to collapse the tree.

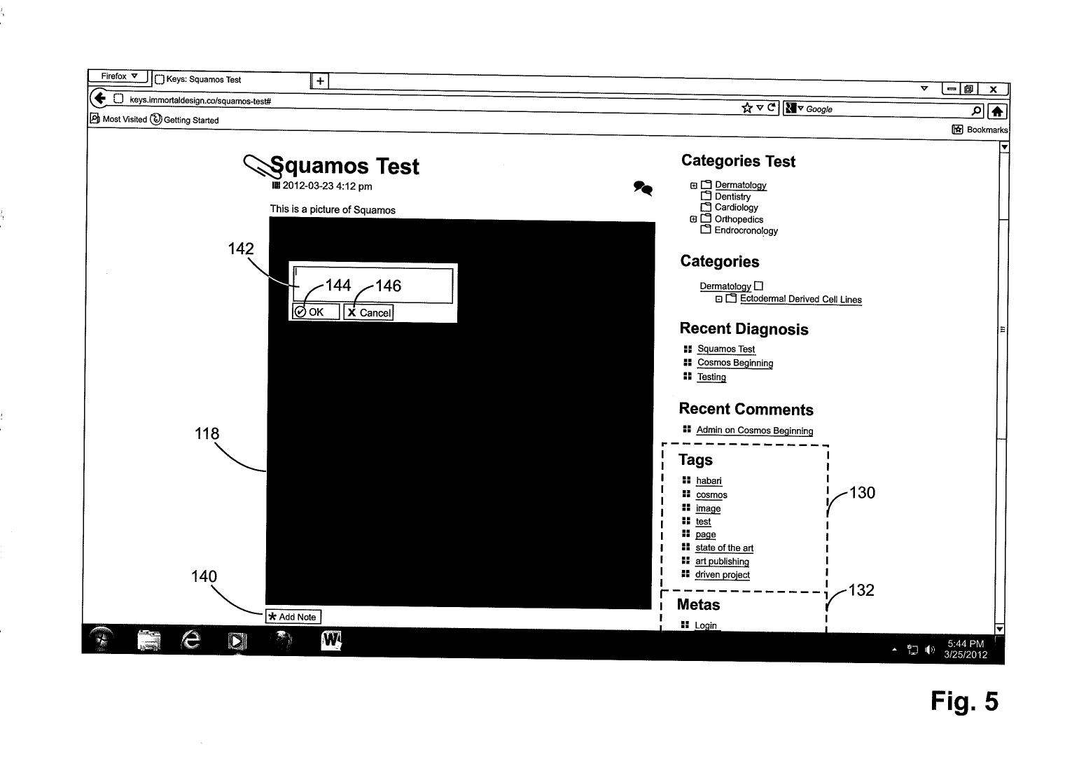

The home web page 116 may also be used to display other material. For example, “Recent Diagnosis”, as illustrated in the dotted box 126. “Recent Comments” may also be displayed, for example in the dotted box 128. As shown in FIG. 5, “Tags” may be displayed, as indicated by the dotted box 130. The tags are used as bookmarks to enable quick access to selected postings. As will be discussed below, all entries can be tagged with a tag word. The tag word is posted in the dotted box 130. Selection of the tag word in the dotted box will display the postings that have been tagged with the same tag word.

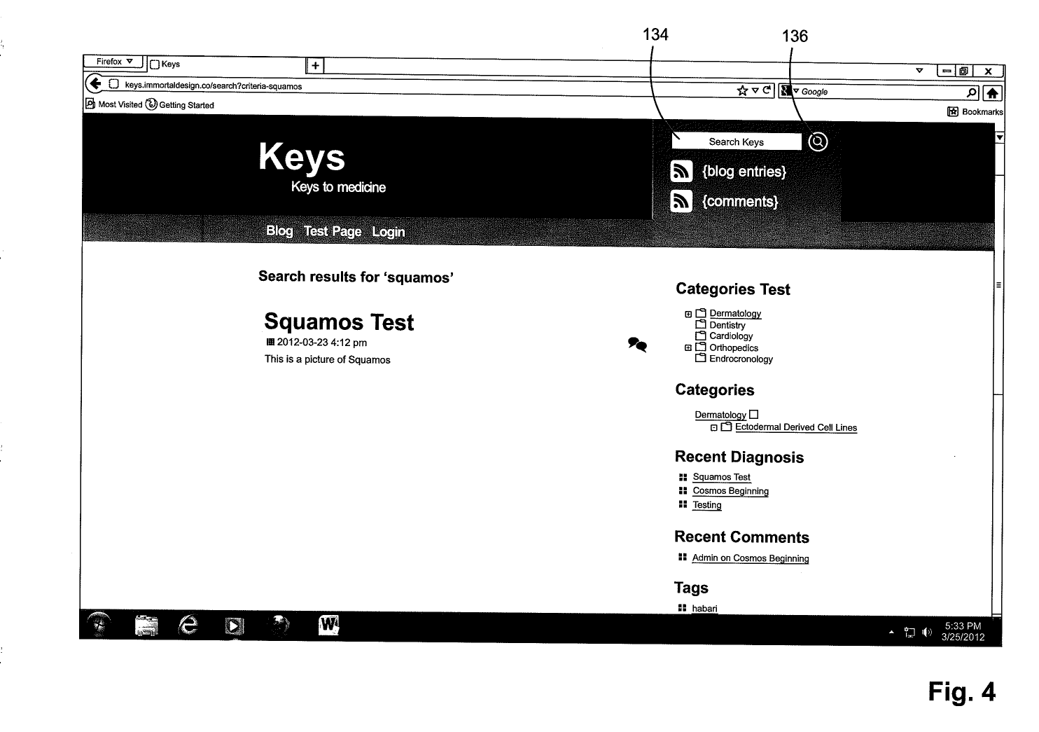

In operation, a user can use the tree diagram, discussed above to view postings and textual material that corresponds to a particular line, e.g. diagnosis, on the tree diagram. Alternatively, the user can search using a search function. In particular, the web portal includes a search box 134 (FIGS. 3 and 4). In this example, the word “squamous” is shown in the box 134 (FIG. 4). Once the search symbol next to the search box 134 is selected, the search results, i.e. squamous postings are displayed. In this example, the search results are displayed as “Squamous Test”. The user can click on the words “Squamous Test” and a picture 138 of a squamous cell is displayed, as illustrated in FIG. 5.

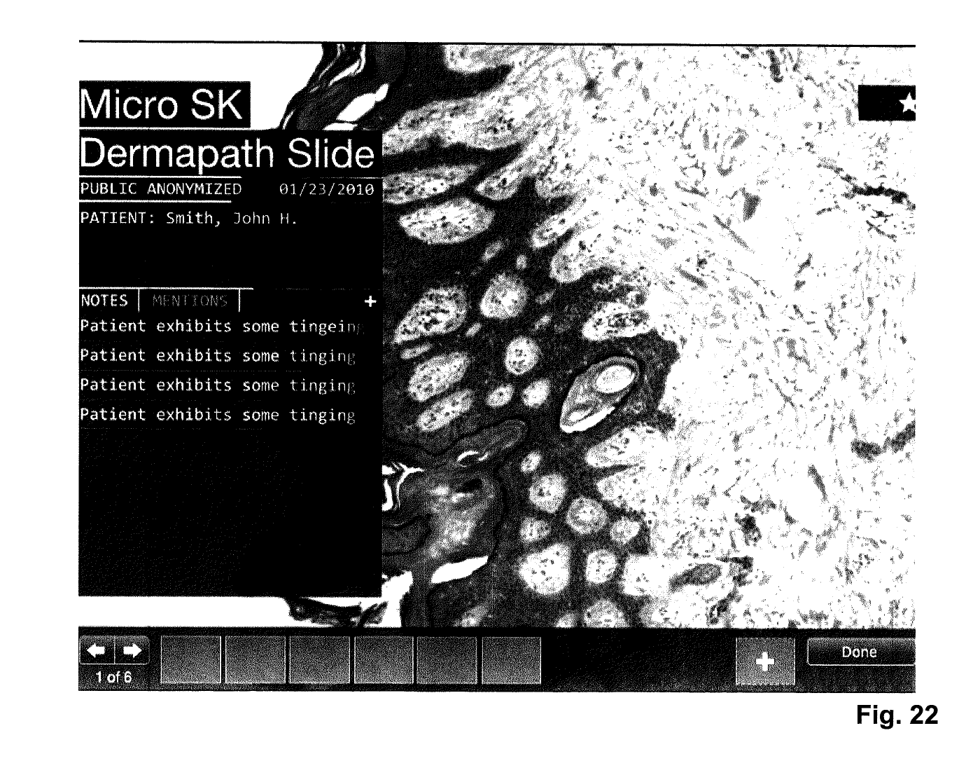

One of the features of the invention is a user's ability to annotate images in the system irrespective of whether the images are posted by the administrator or the user himself. As such, a button 140, identified as “Add Note” is available adjacent the image to annotate images. When the “add Note” button 140 is selected, a dialog box 142 appears in the image 138. A user may then move their cursor within the dialog box and type the desired text material. To add the desired text material, the user selects the ok button 144. In this exemplary embodiment, the annotation will show up when the cursor crosses the hot spot and hovers over the hot spot. In that situation, the pre-existing annotation will pop up. The annotation will pop up in the box 142. The user will have various options, such as; view the pre-existing annotation; modify all or part of the pre-existing annotation; or delete the annotation altogether using the cancel button 146. Other types of annotations are contemplated, for example, as illustrated in FIG. 22.

If the user wishes to add images, the user selects the log-in button 148 on the home page. The log-in button 148 is one of three exemplary buttons, shown on the home page 116. The home page may include a page button 150 to display pages added by the administrator. As will be discussed below, only the administrator may be allowed to add pages. Users are allowed to add entries. The third button may include a blog button 152. Selection of the blog button may be used for communication between the user and the administrator or alternately between the administrator and all users or between users and between all users and the administrators collectively.

One of the features of the invention is that users can personalize their electronic textbook. In addition to annotating images, as discussed above, users can personalize their electronic textbooks by adding their personal entries for images and comments. In order for a user to add entries, the user selects the “Log-In button” 148 on the home page 116.

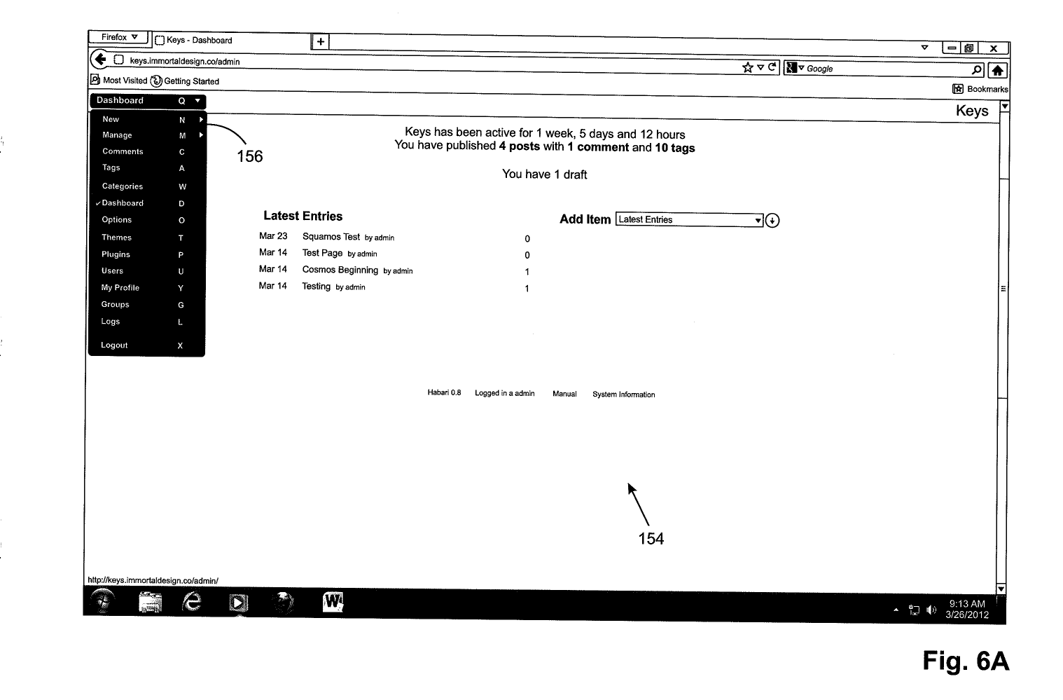

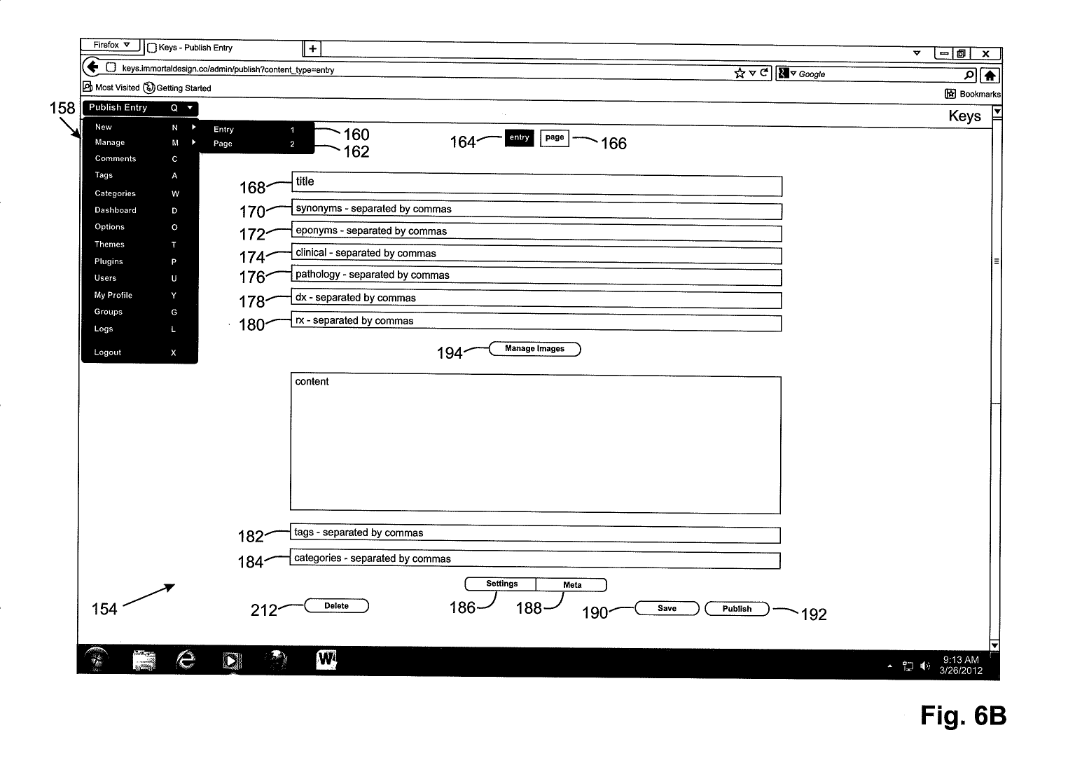

Once the user logs in, a navigation page 154, as illustrated in FIG. 6 is displayed. The navigation page 154 includes a “Dashboard” 156 and may include a log of the latest entries. As discussed previously, these latest entries are published on the home page 116 (FIG. 3). The Dashboard 156 is used by both the user and the administrator to navigate the system. As mentioned above, the user can personalize his electronic textbook by adding their own images and annotating their images. The Administrator also uses the dashboard 156 to add pages and entries to the system. These pages are added to all users' electronic textbooks. As used herein, pages are read/write accessible by the administrator but only read accessible by the users. However, as mentioned above users can add annotations to pages but cannot alter the pages. The web pages for a “page” and an “entry” may be identical in format. The only thing that distinguishes the two are the users to which the pages are published.

As shown in FIGS. 6A and 6B, the dashboard 156 includes a button 158, identified as “New”. When the New button 158 is selected, two other buttons pop out; namely an “Entry” button 160 and a page button 162. Selection of the “Page “button 162 will cause the entries to be published to all users. Selection of the “Entry” button 160 will only cause the entry to be published to the initiating user. The selection of a Page or an Entry may also be made by selecting the Entry button 164 or the page button 166 on the top of the page 154.

The navigation page allows images to be added as well as text information. A number of exemplary text boxes 168-180 may be included on the navigation page. These text boxes may include a “title” text box 168; a synonym text box 170; an “eponym” text box; a “clinical ” text box 174; a “pathology” text box 176; a “Dx” text box 178; and a “Rx” text box 180. The title refers to the diagnosis. Synonyms refer to synonyms for the diagnosis. For example, Lupus is a synonym for SLE. Eponyms refer to the names of people that certain diseases are named after. For example, Lou Gehrig's disease is named after a famous baseball player named Lou Gehrig. This disease is also known as Amyotrophic lateral sclerosis or ALS. Clinical refers to image names. For example, FIG. 22 illustrates a dermatopathology slide. Pathology can be used to illustrate a pathology tree of all of the levels in the tree 122 (FIG. 3) discussed above to down to the specified diagnosis. Dx refers to the actual diagnosis and Rx refers to the treatment.

There are also several other boxes on the web page to be described. The tags box 182 lists other places, for example, diagnosis, to upload the data from the web page. For example, if the information for the web page 154 is to be uploaded under squamous cells, the user may also want to upload the information under lupus as well. In such a situation, the tag would be lupus. A categories box 184 may be provided. The categories box allows the user to indicate a new category not currently listed in the tree 122 (FIG. 3). A settings box 186 allows a user/administrator to switch between “draft” and “publish”. A meta button 188 allows meta data to be input in a separate dialog box and associated with a specific entry or post. The meta data is not published and is only available when the navigation page 154 is retrieved for a particular diagnosis.

The web page 154 also includes a save button 190 and a publish button 192. The save button 190 allows any information placed on the page 154 to be saved in draft form. The publish button 192 causes the data and/or images uploaded to the page to be published to the web site.

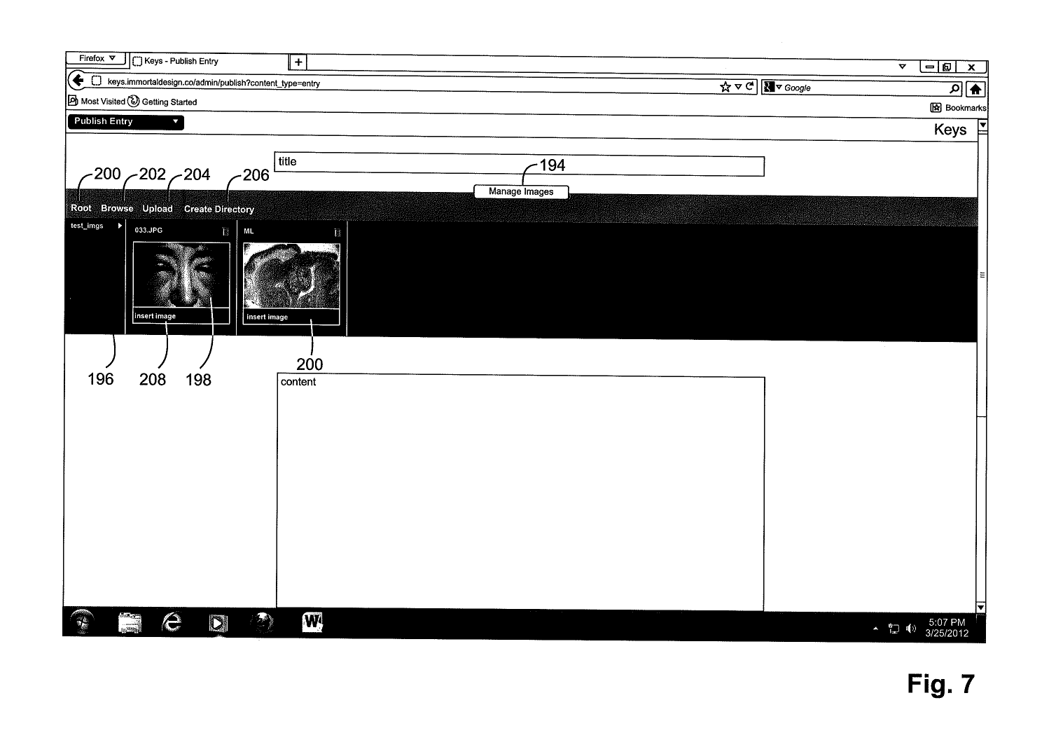

FIGS. 7-11 illustrate how images are uploaded to the system. Referring first to FIG. 6B a manage image button 194 initiates the process of adding images to the site. Once the button 194 is selected, an image navigation bar 196 is displayed. The image navigation bar 196 includes images that have been uploaded to the system. As shown, the image navigation bar 196 illustrates that the images 198 and 200 have been uploaded to the system.

The image navigation bar 196 also includes navigation buttons 200, 202, 204 and 206. The button 200 is a root directory button. The root directory button 200 displays images stored in a root directory on the image navigation bar 196. Subdirectories can be added and deleted by way of a create directory button 206. This allows subdirectories to be created and images to be stored in subdirectories. The upload button 204 allows images to be uploaded under the root directory or a subdirectory. A browse button 202 allows browsing of images in the various directories.

With reference to FIG. 7, each image that is uploaded includes an insert image button 208. All images are loaded onto image navigation bar 196. In particular, images are loaded onto the root directory or a subdirectory. In order to load an image onto the root directory, the root button 200 is selected. When the root button 200 is selected, all images stored under the root directory are displayed on the image navigation bar 196. Similarly, when the browse button 202 is selected, all subdirectories are displayed adjacent the image navigation bar 196. Once a particular subdirectory is selected, the images in that subdirectory are displayed on the image navigation bar 196.

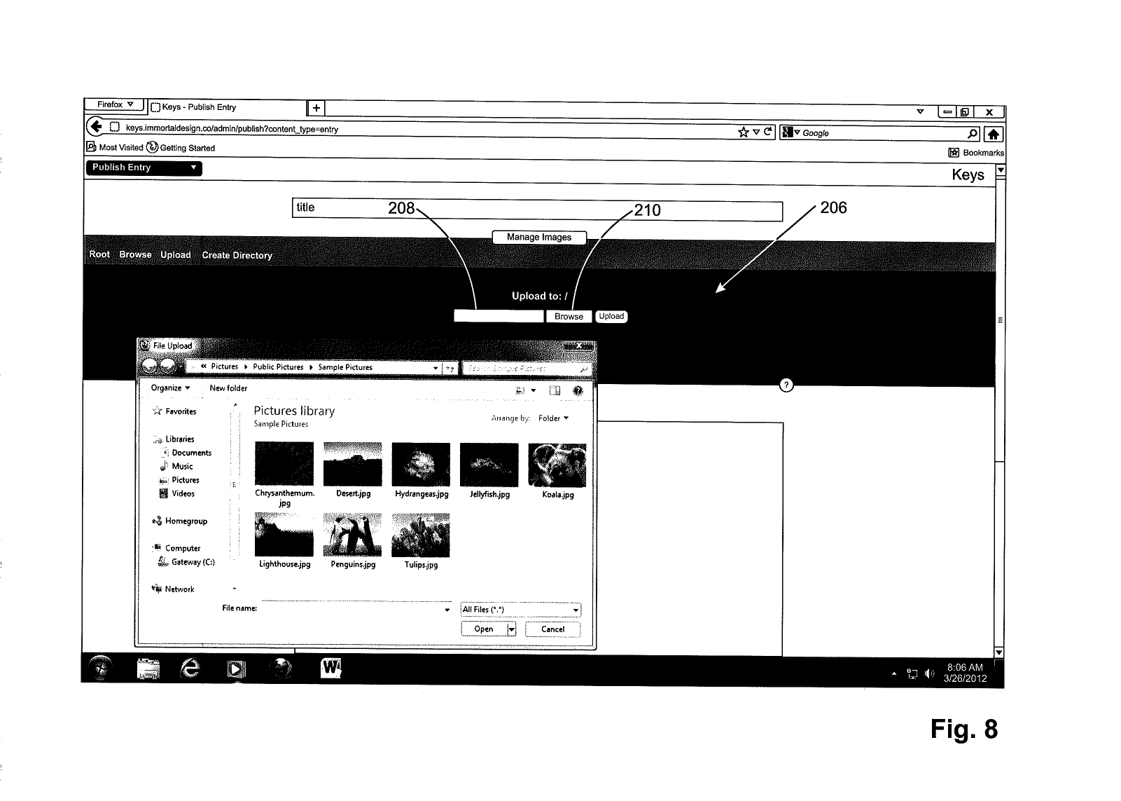

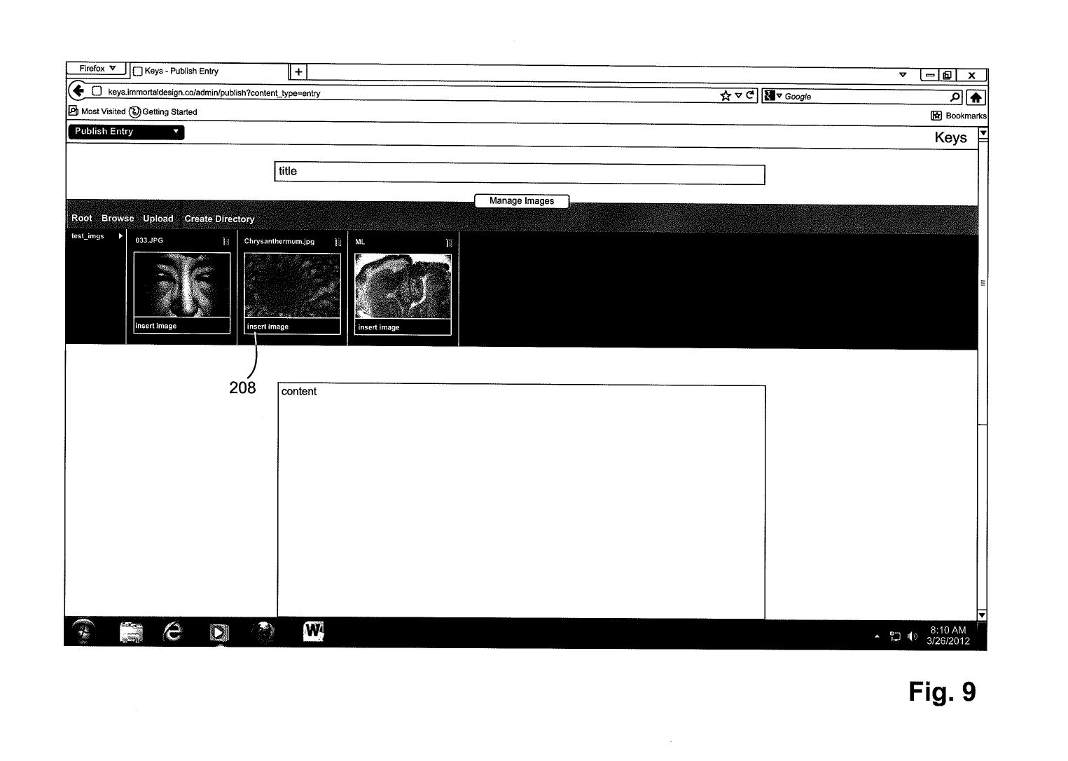

An exemplary upload to the root directory is illustrated in FIGS. 8-11B. In this exemplary case, a picture from a picture library was uploaded to the system. This process is initiated by selecting the “Manage Image” button 194 (FIG. 6). Once the “Manage Image” button 194 is selected, the image navigation bar 196 is displayed. In order to add a new image in this example to the root directory, the upload button 204 is selected. Selection of the upload button 204 displays a dialog box 206. The dialog box 206 includes a text box 208 for identifying the file path in the user's personal computer for the image to be uploaded. The browse button 210 allows the user to browse stored images and select one for upload. In this example, an image from the user's photo library is selected. In the example, an image of a chrysanthemum is selected by the user by selecting the desired and either clicking on the image or opening the file for the image. By doing so, the file path on the user's computer is written to the text box 208 and the image is uploaded to the image navigation bar 196, as illustrated in FIG. 9.

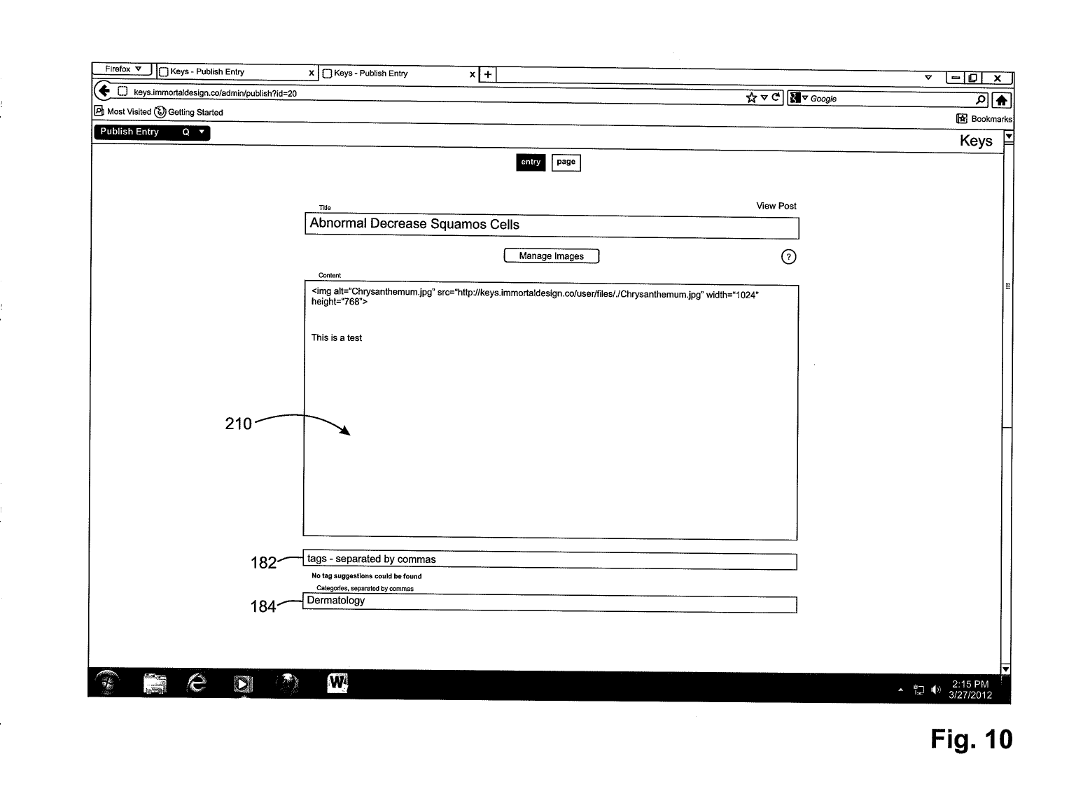

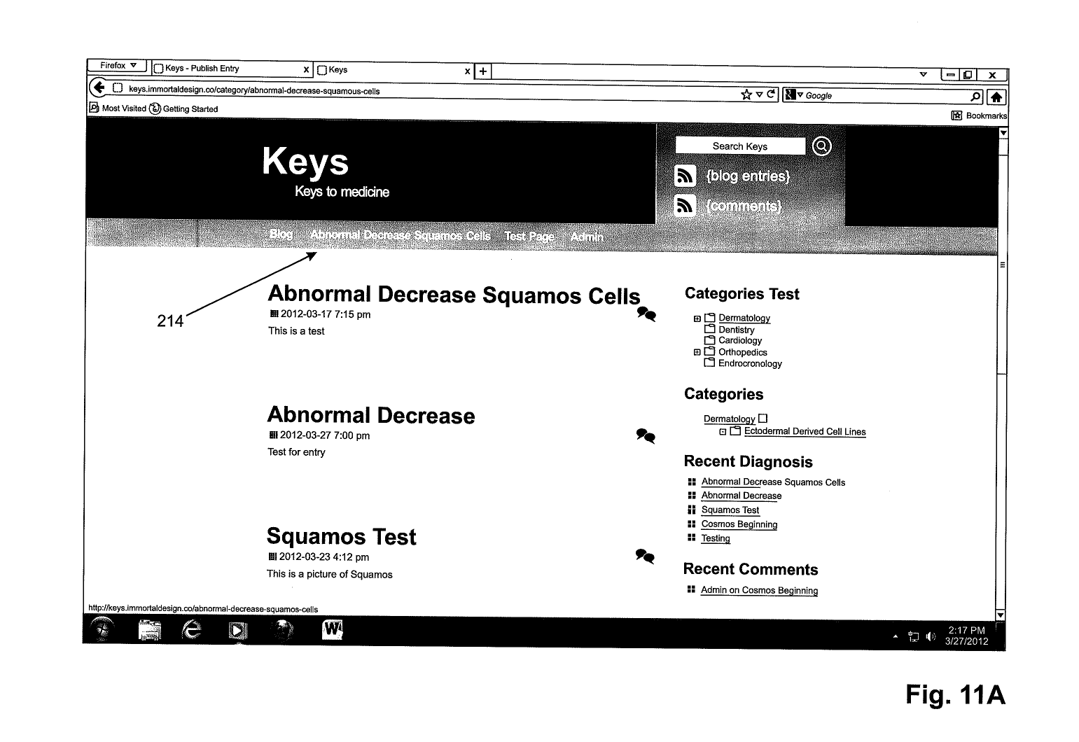

Once the desired image is uploaded to the image navigation bar 196, the insert image button 208 on the image is selected. As shown in FIG. 10, selecting the insert image button 208 causes the file path to be written to the content box 210. In addition to the file path, additional text can be written in the content box 210. The tag box 182 and the category box 184 are also filled in to locate this entry in the user's desired location on the tree 122 (FIG. 3). The user may add save the content as a draft by selecting the save button 190 or publishing the content by selecting the publish button 192.

The user may also add text to the content box 210. The image and content in the content box 210 are viewable by the administrator and can be added to the outline as a generic feature. Alternatively, the text can be added in a separate box (not shown) that is not available to the administrator. In such an embodiment, only the image is available to the administrator.

As shown in FIGS. 6A and 6B mentioned previously, the user also has other options. For example, the user has the option of first saving the content and publishing it later by returning to the page later and selecting the setting button 186 which allows for changes between draft and publish and vice versa. The user can also add metadata by selecting the metadata button 188. The user also has the option of deleting the content by selecting the delete button 212.

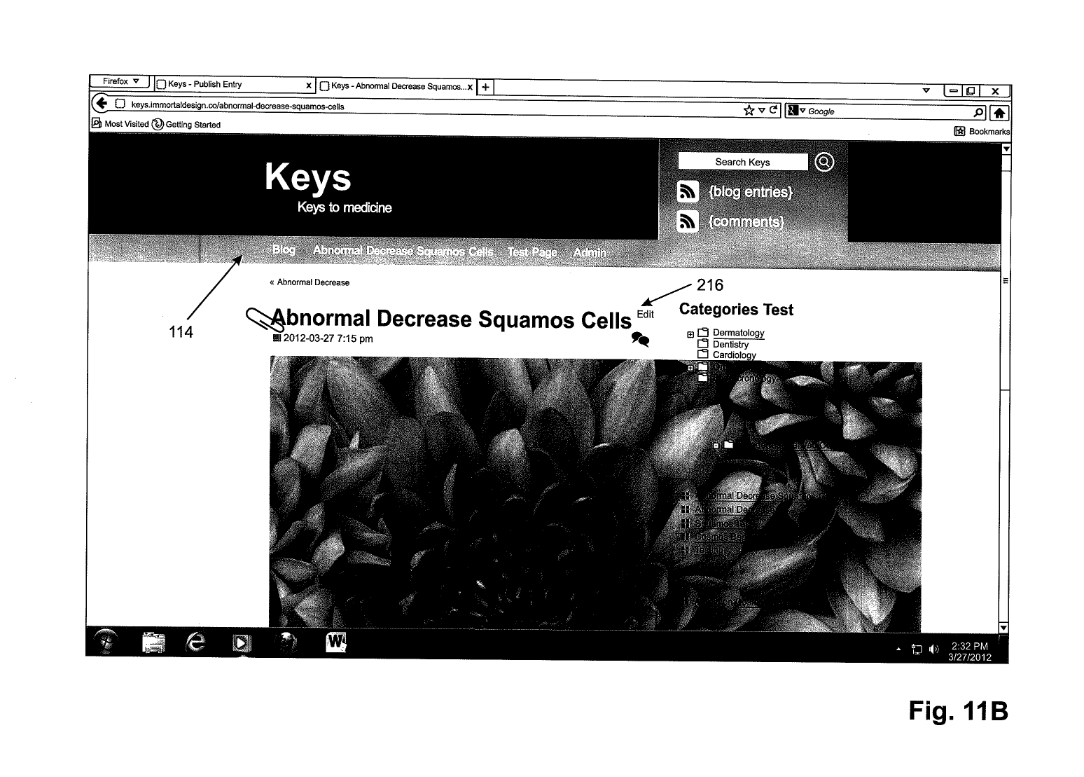

As shown in FIG. 10, the title is selected as “Abnormal Decrease Squamus Cells” and the category is selected as “Dermatology”. Once the publish button 192 (FIG. 6) is selected, selection of the diagnosis Abnormal Decrease Squamous Cells from the tree 122 (FIG. 3) or using the search box 134 (FIG. 3) will cause a listing of entries under the diagnosis “Abnormal Decrease Squamous Cells” to be displayed. FIG. 11A illustrates three entries as follows that are under the “Abnormal Decrease Squamous Cells” diagnosis on the tree 122 (FIG. 3). These entries are shown in FIG. 11A as: “Abnormal Decrease Squamous Cells”; “Abnormal Decrease” and “Squamous Test”. Clicking on any of these entries will cause the posting to be displayed as indicated in image and content to be displayed as indicated in FIG. 11B. The most recent posting is also displayed in a status bar 214, adjacent the “blog” button 152 and the “login” button 148 (FIG. 3). An edit button 216 is included which allows the content defining this entry, i.e. FIG. 10 to be edited.

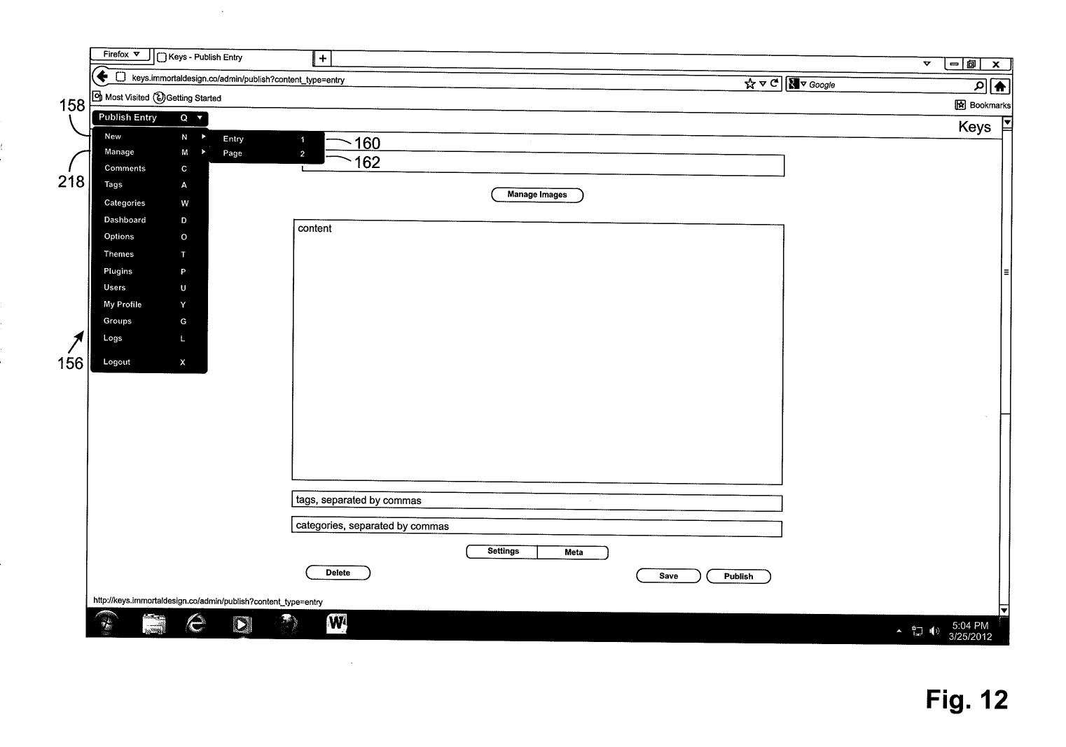

Referring to FIG. 12, the dashboard 156 provides navigation around the website. As mentioned above, the dashboard 156 includes a “new” button 158. The “new” button allows pops out to a” page” button 160 (FIG. 6) and an “entry” button 162. These buttons 160 and 162 function in a similar manner, except content added by way of the “entry” button 160 is only published to the user whereas content added by way of the “page” button 162 is published to all users. Only the administrator has read/write access to content published by way of the page button 160. Users only have read access to content published by way of the page button 160. Each user has read/write access to his own content added by way of the “entry” button 160. Users may be given access to other users content, as discussed below.

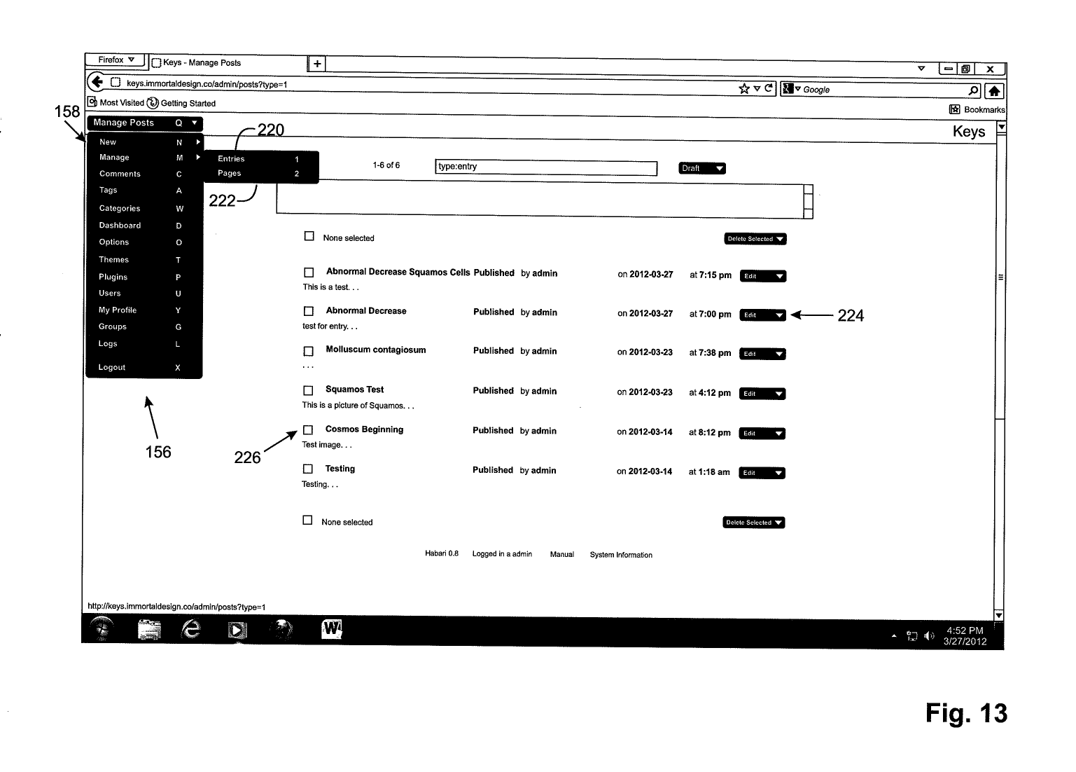

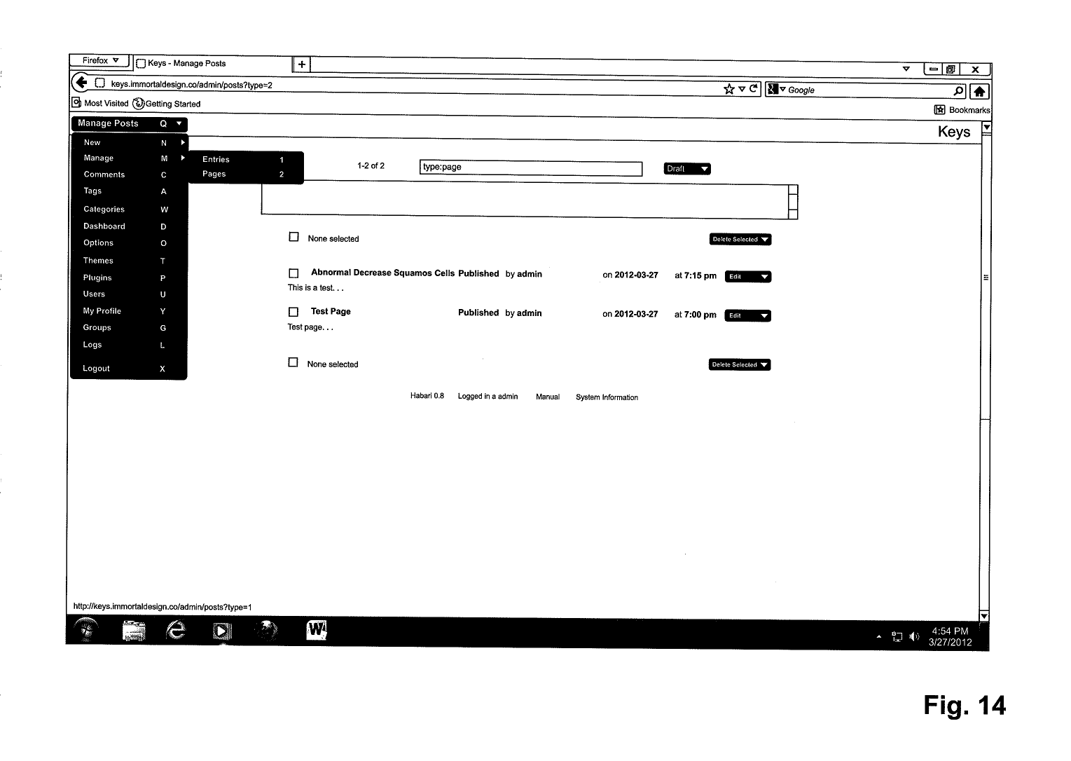

A “Manage” button 218 on the dashboard 156 allows both entries and pages to be edited or deleted. FIG. 13 illustrates a situation when the manage entry button 220 is selected. FIG. 14 is basically the same as FIG. 13 but relates to pages. For brevity only entries will be described below. As shown a number of entries are listed. Each entry identifies the title of the entry, the author, whether the entry was published or in draft form and the date and time of the entry. In this example, all entries identify the administrator as the author. When the website goes live, the authors will be the individual users. Each entry contains an “Edit Box”, generally identified with the reference numeral 224. The Edit box 224 includes an arrow, which when selected, initiates a drop down menu which includes three buttons; an edit button, a view button and a delete button (not shown). Selection of the edit button retrieves the content page illustrated in FIG. 10. Changes can be made by simply editing the content on the content page and saving the page as discussed above. The view button retrieves the image as shown in FIG. 11B. Selection of the delete button deletes the entry. Each entry also includes a check box, generally identified by the reference numeral 226. A “Delete Selected” button is provided. Selection of the Delete Selected button deletes all entries with a check mark in the check boxes 226.

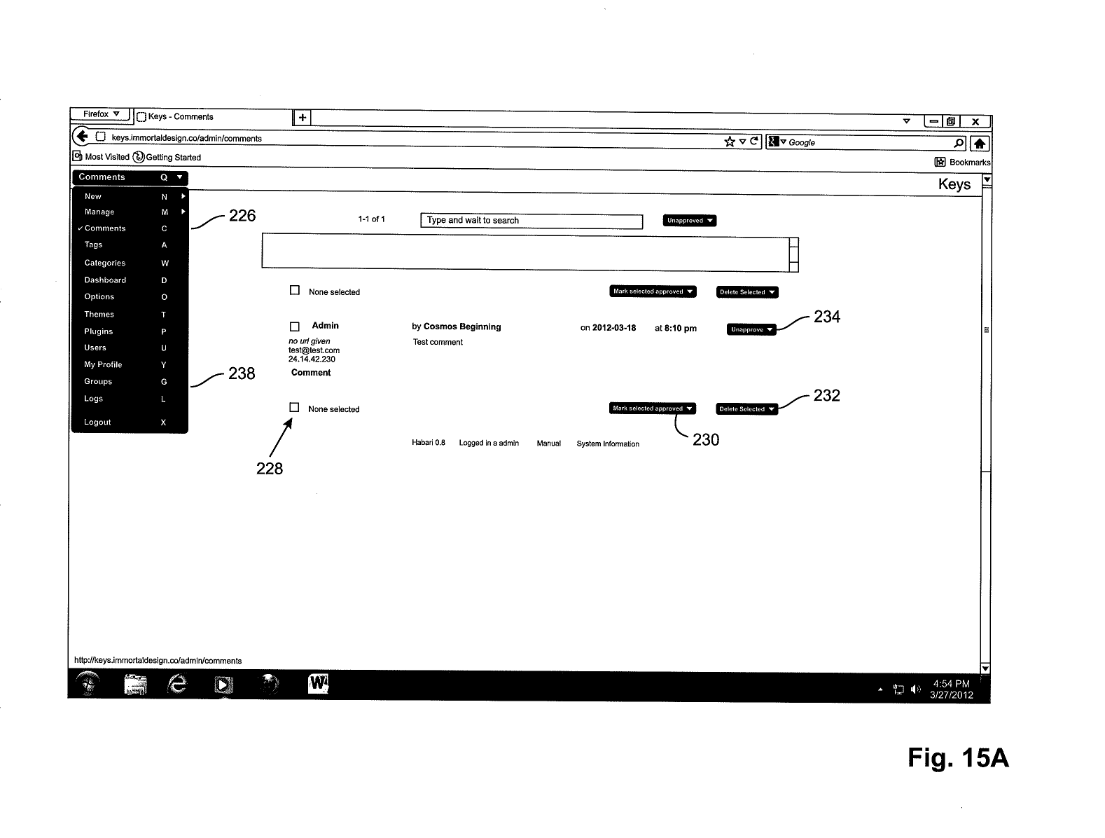

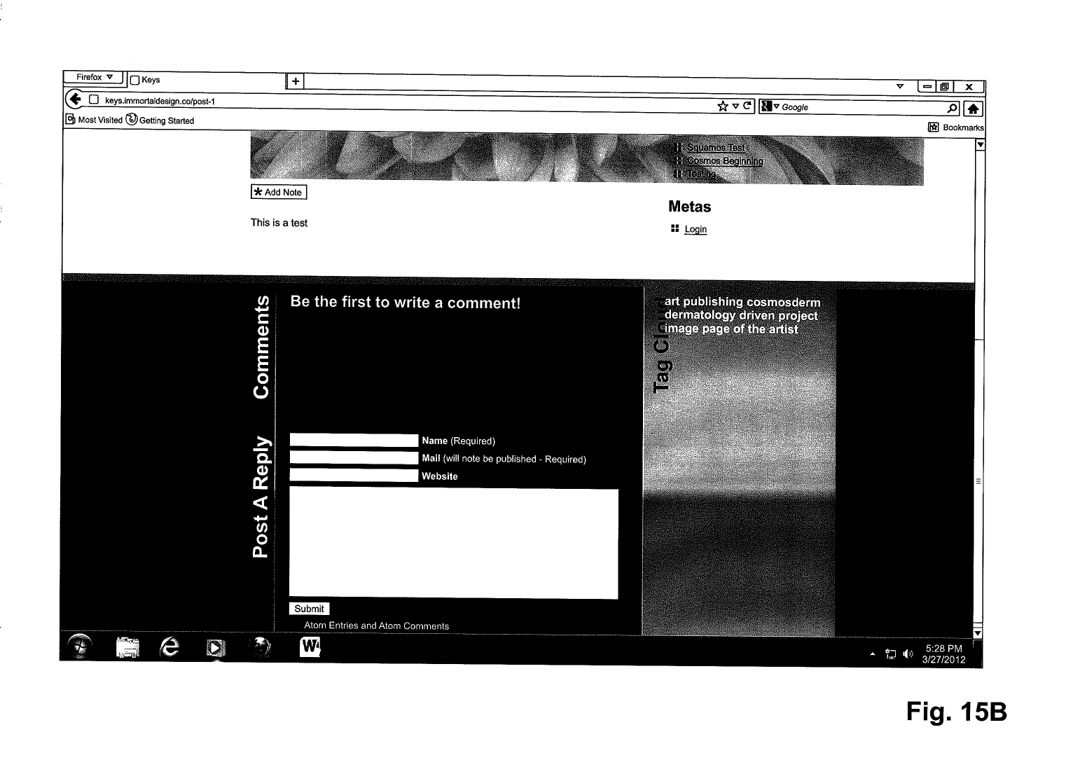

FIG. 15A illustrates a comments button 226 on the dashboard 156. The comments button lists all comments posted to a particular image. In particular every image, such as the image illustrated in FIG. 11B, may include a comment portion beneath the image, as shown in FIG. 15B. The comments portion is meant to solicit comments from the users to the administrator. These comments are tabulated when the comments button 226 on the dashboard 156 is selected. Each comment includes a check box, generally identified with the reference numeral 228. These comments may be approved or disapproved by the administrator. The page includes a “Mark Selected Approved” button 230; a “Delete Selected” button 232. When any of the check boxes 228 are selected, if the Mark Selected Approved” button 230 is selected, all of the selected comments will be approved. Similarly, if the “Delete Selected” button 232 is selected, all of the selected comments will be deleted. There may also be a “Un-approve” button 234 next to each comment. Selection of the Disapprove button 234 will cause a comment to be disapproved.

Each of the buttons may be configured as drop down menu. The Mark Selected Approved button 230 may drop down to three buttons; “Mark selected approved”; Mark selected disapproved; and Mark selected spam. Similarly, the delete selected button 232 may drop down to contain three buttons: delete selected; delete spam; and delete all unapproved. The un-approve button 234 may drop down to contain to contain four buttons: unapproved, delete; spam and exit.

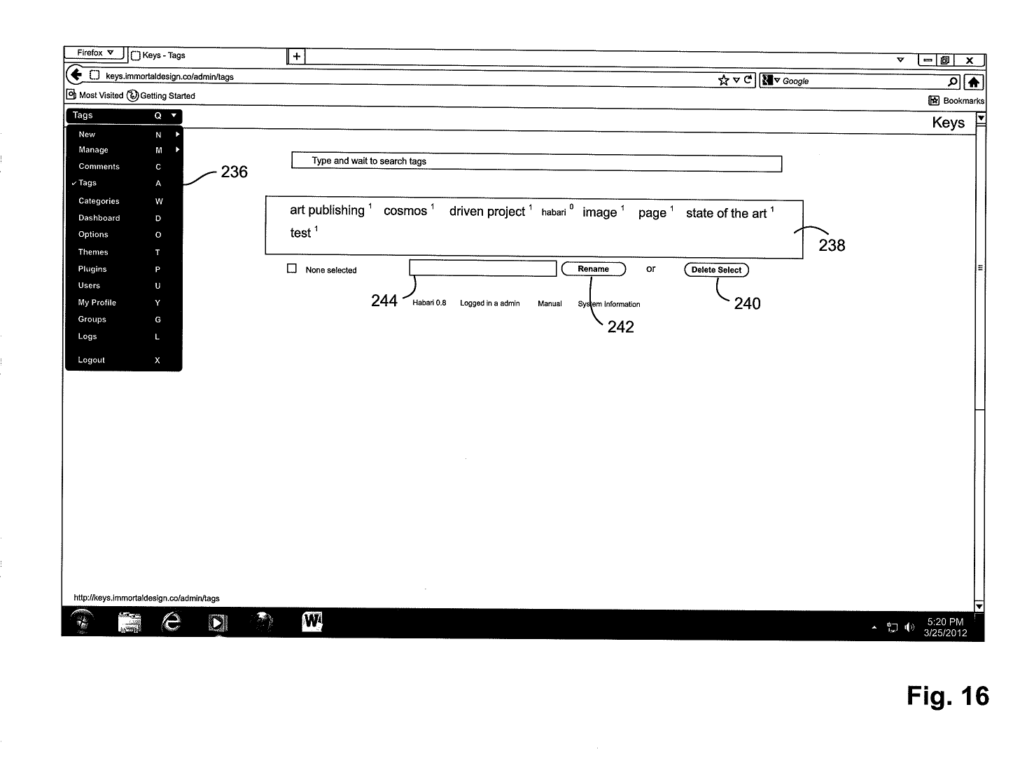

A tags button 236 on the dashboard identifies all of the various tags that have been used to date by the user, FIG. 16 illustrates an exemplary page when the tags button 236 is selected on the dashboard 156. As shown, all of the various tags that have been used are identified in a dialog box. Any tag can be deleted by highlighting the tag with a cursor and selecting a “Delete Selected” button 240. Tags can also be renamed by highlighting the tags and selecting the Rename button 242 and typing the new name in the dialog box 244.

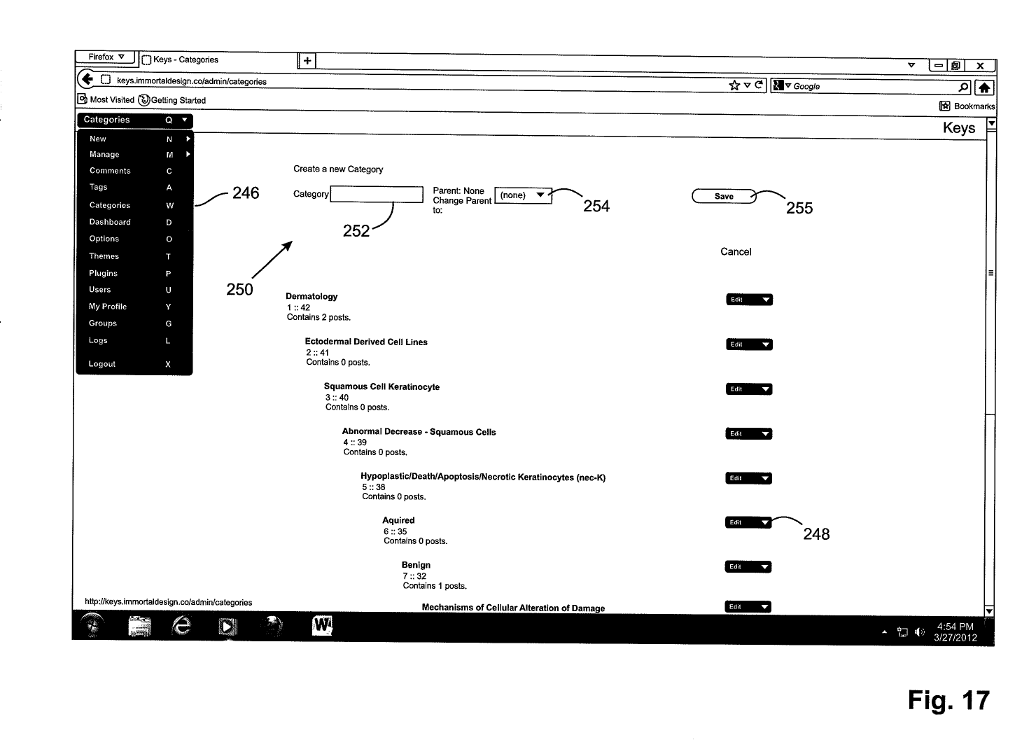

FIG. 17 illustrates the Categories button 246 on the dashboard 156. When the categories button 246, all of the various diagnosis categories illustrated in the tree 122 (FIG. 3) are illustrated. Each category contains an edit button 248 which allows a category to be edited or deleted. Selection of any of the categories retrieves posted pages and entries for the selected category. The box 250 at the top of the page allows new categories to be created. In particular, the box 252 is a dialog box that allows new categories to be added. The box 254 governs the placement of the new category in the tree 122 (FIG. 3). In particular, the box 254 is a drop down list of all of the various categories in the tree 122. Selection of a category from the drop down list identifies the parent of the newly added category. The parent is the category directly above the new category in the tree 122 (FIG. 3).

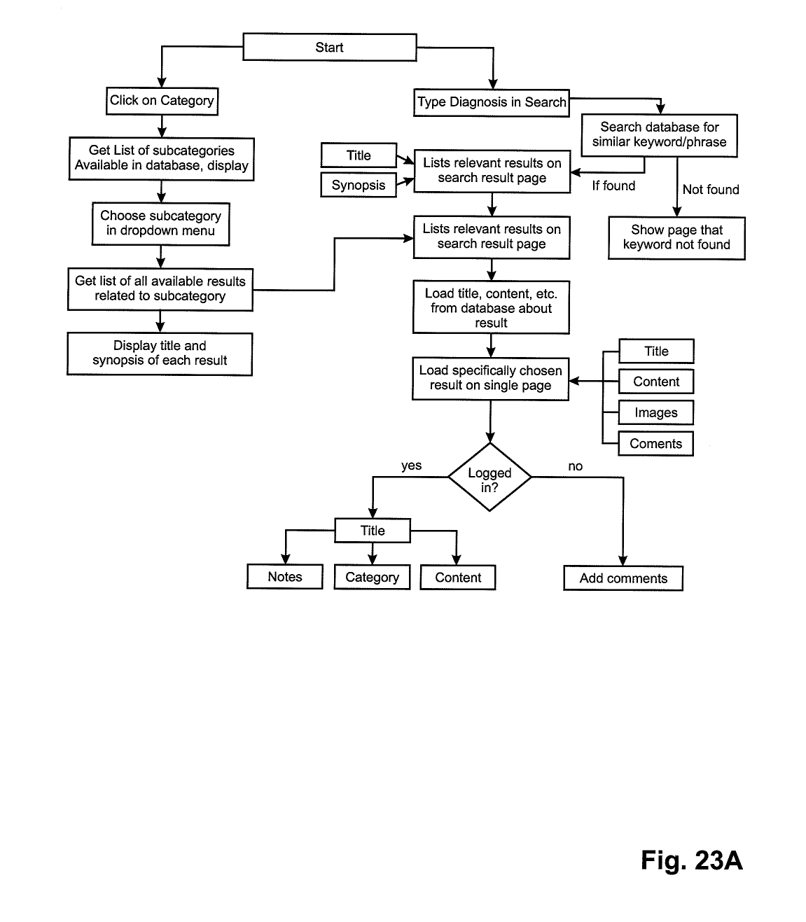

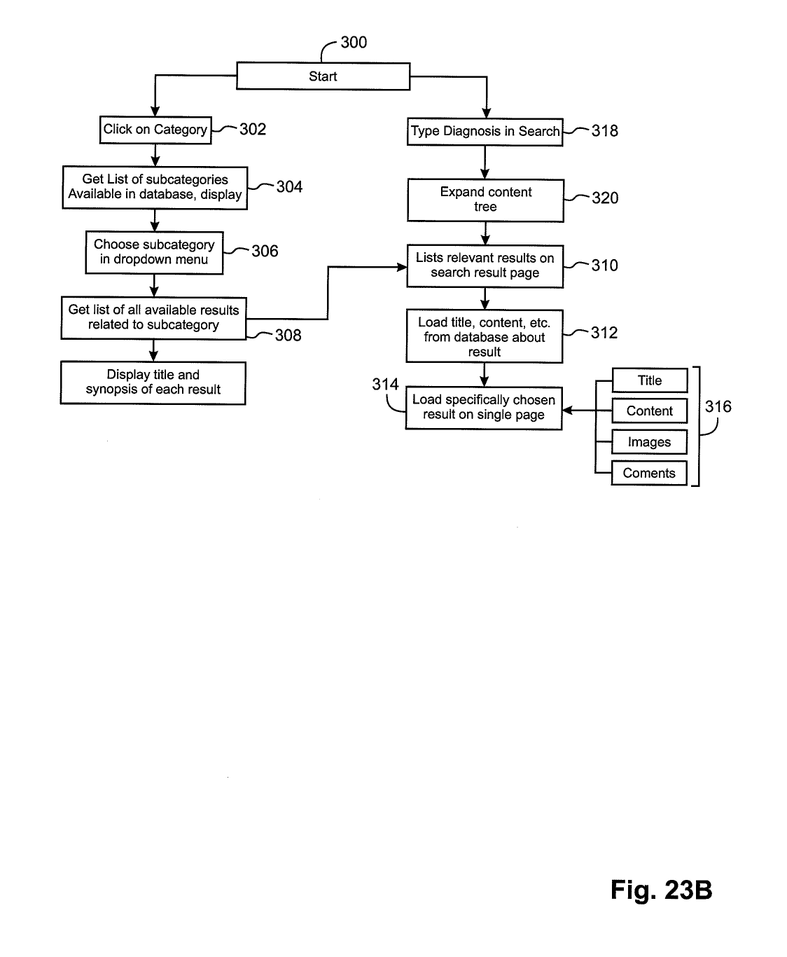

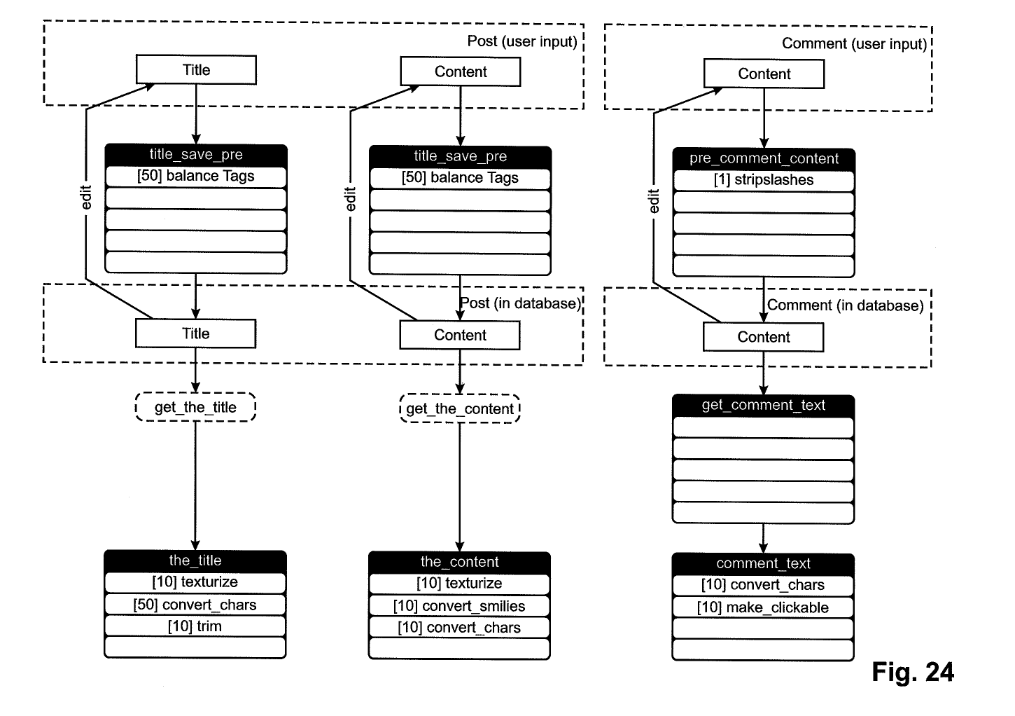

FIGS. 23A and 23B are similar. For brevity only FIG. 23B is discussed. The main difference between the two Figs. deals with the point in the process when the when the user needs to be logged on to the main server 100 (FIG. 1). In FIG. 24A, the user can access their own electronic book and locally annotate and add images to the electronic book before logging onto the main server 100. In order to upload any annotations or images, the user must then log on to the server 100 (FIG. 1). In FIG. 24B, the user must be initially logged on to the server 100 before any access to the electronic book is provided.

Referring to FIG. 23B, it illustrates a logic flow diagram that provides a simplified version of the logic discussed above. Initially in step 300, the user needs to decide whether to use the content tree or the search dialog box to get to the content of interest. In the case of a medical textbook, if the user initially clicks on a specific category 120 (FIG. 3), for example, Dermatology in step 302. In step 304, the user selects the drop down menu button 124 (FIG. 3) to obtain a list of the available subcategories in the Master Database Tables 104 (FIG. 1). The user selects a list of subcategories in step 306, for example, Ectodermal Derived Cell Lines (FIG. 3). The drop down menu may then be selected in step 308 to get a list of subcategories. As shown in FIG. 3, one subcategory is Squamos Cell Keratinocyte. A drop down menu adjacent the entry Squamos Cell Keratinocyte may be selected to illustrate subcategories under Squamos Cell Keratinocyte. That step reveals “Abnormal Decrease—Squamos Cells in step 310. Assuming this is the desired diagnosis/category, the user wants to annotate or add images as in step 312 or 314 as illustrated and discussed above in connection with FIGS. 6A, 6B and 7 and identified with the reference numeral 316.

Alternatively, the user can simply enter the diagnosis in the search dialog box 134 (FIG. 3). The content tree will automatically expand to illustrate all categories and sub-categories in the content tree that correspond to the selected category/subcategory in Step 320. The illustrated categories/subcategories may be illustrated in various ways, such as highlighting, flashing, different colors and other ways.

FIG. 24 illustrates the structure of an exemplary database and the dataflow to the database in accordance with the first embodiment of the invention, as discussed above. Users may also share their entries with other users or groups of users. In this case, the user selects the Groups button 238 (FIG. 15A) on the dashboard 156. The groups button 238 allows a user to share entries with other users. By selecting the Groups button 238, the user has the ability to define a group or select a previously defined group to share a page with.

### Second Embodiment of the Invention

FIGS. 18-22 relate to an alternative second embodiment of the invention. The functionality of the second embodiment of the invention is similar to the first embodiment. As such, these Figs are not discussed in detail.

### Data Flow

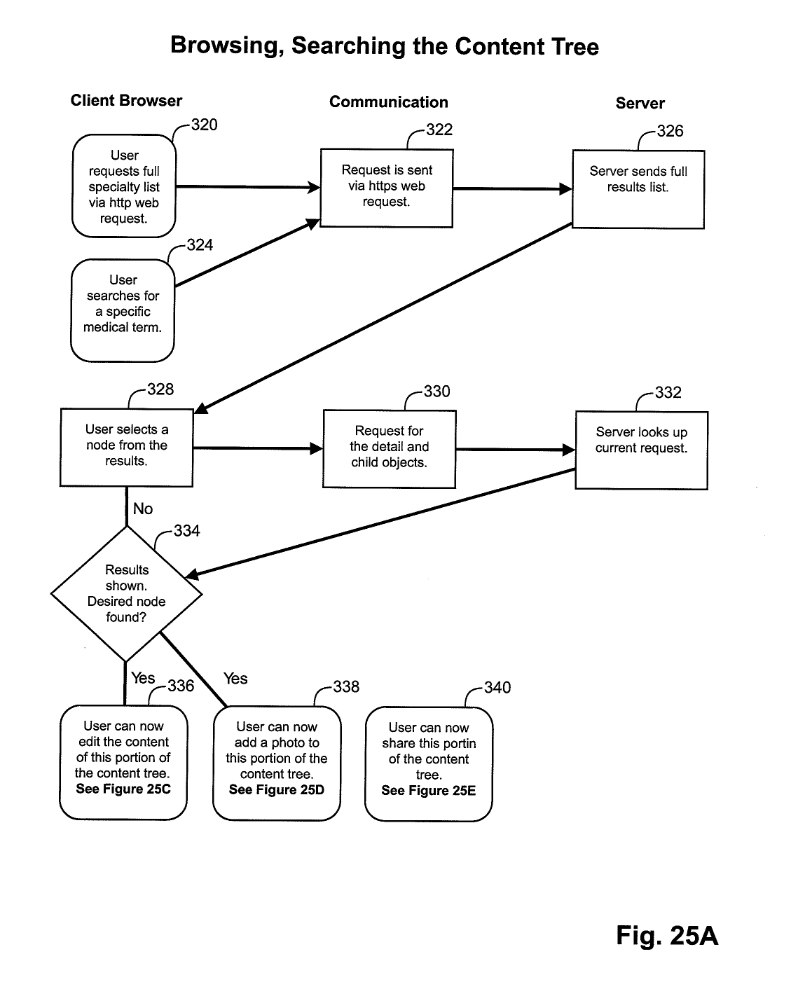

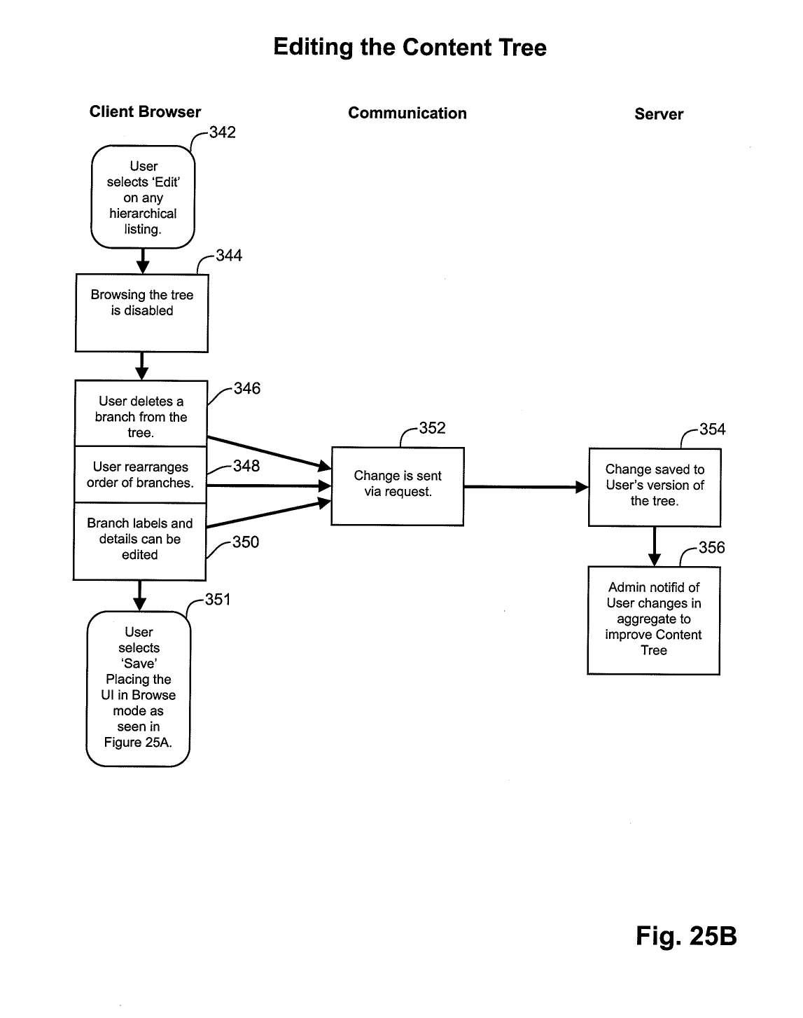

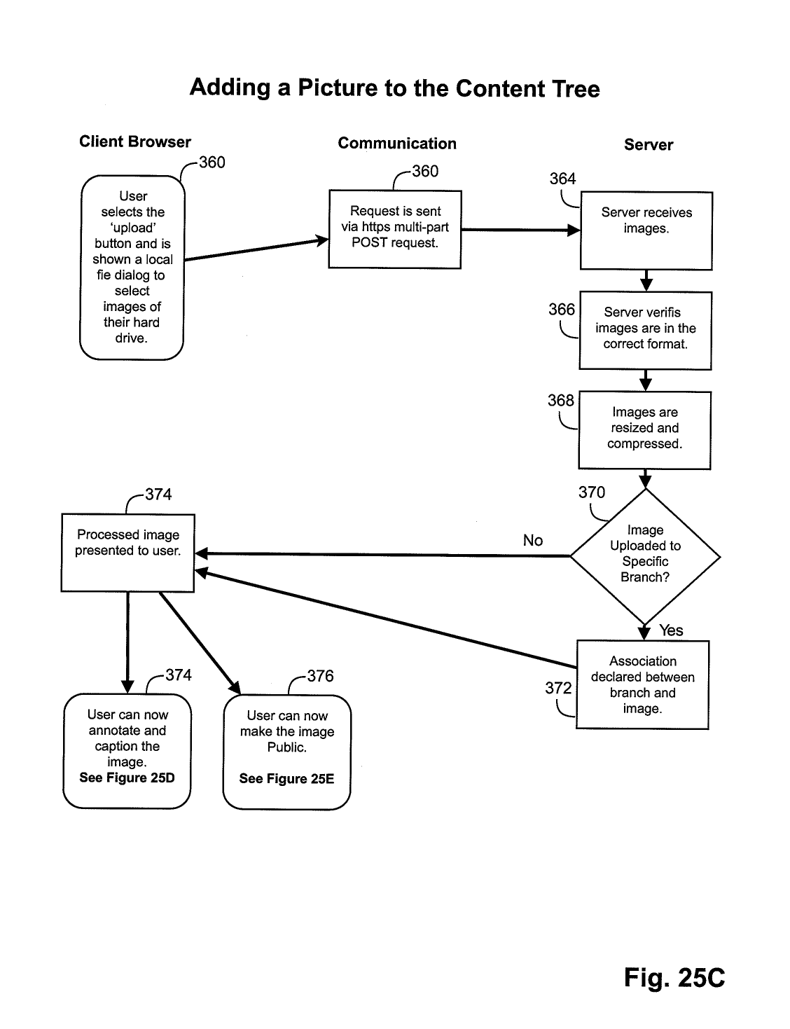

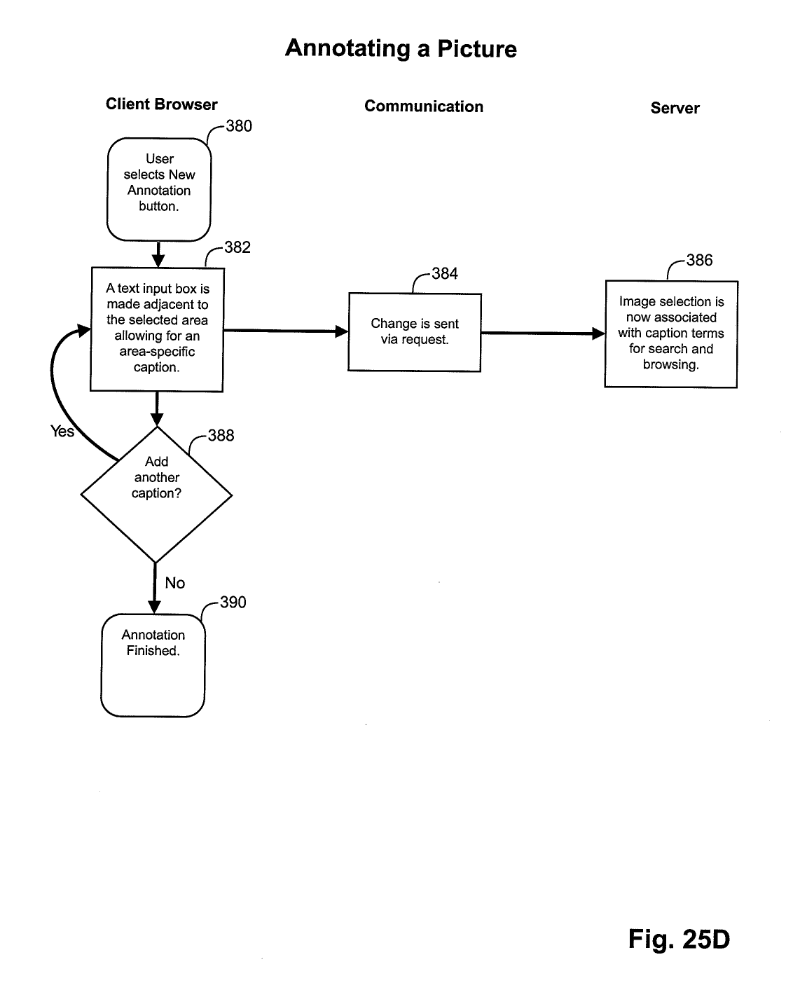

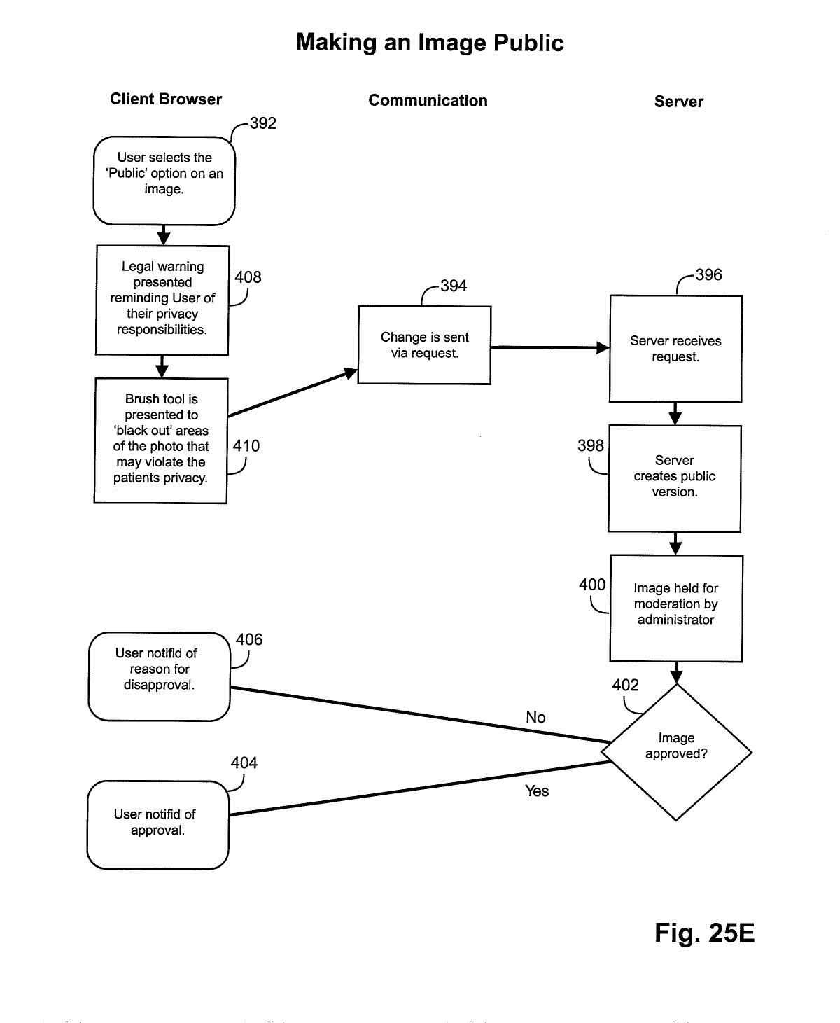

FIGS. 25A-25E illustrate data flow diagrams for various operations with respect to the content tree. FIG. 25A is a data flow diagram for browsing and searching the content tree. Although these diagrams are illustrated in terms of transferring data over the web, the principles of the invention are not so limited and apply to other communication protocols. FIG. 25B is a data flow diagram for editing the content tree. FIG. 25C is a data flow diagram for adding a picture or image to the content tree. FIG. 25D is a data flow diagram for annotating a picture. FIG. 25E is an exemplary data flow diagram for making an image public.

Referring first to FIG. 25A, this figure illustrates the data flow associated with browsing and searching the content tree. Initially in step 320, the user 108, 110 112 requests that the content tree be fully expanded in step 320. This request is sent from the client browser to the server 100 (FIG. 1) by way of a secure, i.e. https://, web request, as indicated in step 322, for example over a wired or wireless communication link. Alternatively, the user 108, 110, 112 places a request in the search box 134 (FIG. 3), as indicated in step. This request is also forwarded to the server 100 (FIG. 1) by way of a secure web request. In step 326, the server 100 returns required information to the user 108, 110 and 112 in the form of, for example, an expanded content list with the various categories/subcategories on the content tree that match the search request annotated for searches initiated by way of the search box 134 (FIG. 3). For searches initiated directly from the search tree, the search tree is selectively expanded to illustrate the various categories/subcategories until the user finds the category/subcategory of interest.

In step 328, the user 108, 110 112 is able to select a node, i.e. category/subcategory of interest. The user may then request additional detail on the selected node, such as clinical data 174(FIG. 6B), pathology data 176, and the like, associated with the selected node in step 330. The requested information is supplied by the server 100 (FIG. 1) in step 332. As indicated in the block 334, the results from the server 100 are selectively displayed. The user 108, 110, 112 has the option of editing the content, as indicated in block 336; add a photo or image, as indicated by the block 338 or share a portion of the content with a third party, as indicated by the block 340.

FIG. 25B is a data flow diagram that illustrates editing the content tree. Editing the content tree, as well as adding and deleting nodes is discussed above by way of an “Edit” button 248 (FIG. 17). Once the edit button is selected, browsing, i.e. responses to selection of drop down menus, may be disabled, as indicated in box 344. As indicated by the boxes 346, 348 and 350, the user 108, 110, 112 has various options once the Edit button 248 is selected. For example, a user 108, 110, 112 can delete a branch from a tree, as indicated by the box 346. The user 108, 110, 112 can also rearrange the order of the branches in the content tree, as indicated by the box 348. The user 108, 110, 112 can also edit branch labels and details, as indicated by the box 350. Once the edits are complete, the user selects the SAVE button 255 (FIG. 17), as indicated by the block 351.

Once the changes are saved, the changes are sent to the server 100 (FIG. 1) by way of a wired or wireless communication link, as indicated by the box 352. The server 100 saves the changes to. User Specific Database Tables 104 and specifically to the User's version of the content tree, as indicated by the block 354. Optionally, the Administrator may be notified, as indicated by the block 356.

FIG. 25C illustrates the data flow in order to add a picture or image to the content tree. In order to add a picture or image to the content tree, a Manage Image button 194 (FIG. 6B) is selected, as indicated by the box 360. The user has the option of uploading images from their hard drive. Once uploaded, the request is sent to the server 100 (FIG. 1), as indicated by the box 362, by way of a wired or wireless communication link. Once the server 100 receives the image, as indicated by the block 364, the server verifies that the images are in the correct format, for example, jpg format, as indicated by the block 366. The server 100 then resizes and optionally compresses the image, as indicated by the block 368. Next in steps 370 and 372, the server 100 attempts to associate the image with the specified category/subcategory. The server 100 then returns the processed image to the user 108, 110 112, as indicated by the block 374. Once the user 108, 110, 112 receives the image back from the server 100, the user can annotate and caption the image, as indicated by the block 374 and optionally make the image public by selecting the Page button 162 (FIG. 6B).

FIG. 25D relates to a data flow diagram for annotating a picture or image. In order to annotate a picture or image, the user selects a new annotation button, i.e. “Add Note” button 140 (FIG. 5), as indicated by the block 380. Once the Add Note button 140 is selected, a dialog box pops up to enable a caption to be input. as indicated by the block 382. Once the User 108, 110, 112 selects the “OK” button 144 associated with the dialog box 142, the annotation is sent to the server 100 by way of a wireless or wired communication link, as indicated by the block 384. The annotation is then associated in the user specific database table 106 or optionally the master database table 104. As indicated by the block 388, the system checks the Add Note Button 140. If the Add Note button is selected again, the system returns to block 382 and repeats steps 382, 384, 386 and 388. If the “Add Note” button 140is not selected again, the system assumes that the annotation is finished, as indicated by the block 390.

FIG. 25E illustrates the data flow for making an image added by a user 108, 110, 112 public. Initially in step 392 by selecting a “New “158 (FIG. 6B) on the dashboard 156. When the New button 158 is selected, two other buttons pop out; namely an “Entry” button 160 and a page button 162. Selection of the “Page “button 162 will cause the entries to be published to all users. This request is sent to the server 100 (FIG. 1), as indicated by the block 394. In step 398, the server 100 creates a public version by storing a copy in the Master Database tables 104 and associating the image with a specific category or subcategory after approval by the Administrator, as indicated in step 400. If approved, the image is made available on the Master Database Tables 104 and the user is optionally notified, as indicated by the block 404. If the image is not approved, the user is optionally notified, as indicated by the block 406. The system may optionally include image editing tools 408 and 410, which allows portions of the images to be blacked out to avoid violating patient privacy rights.

### Exemplary Database Structures

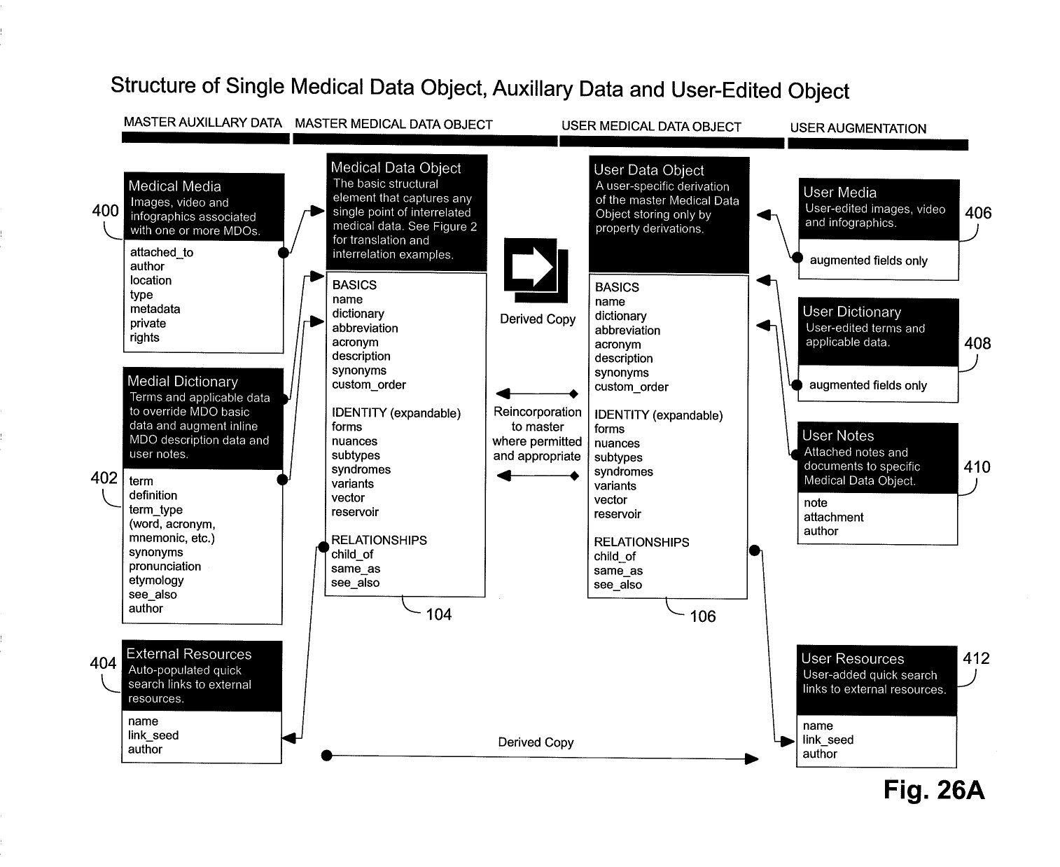

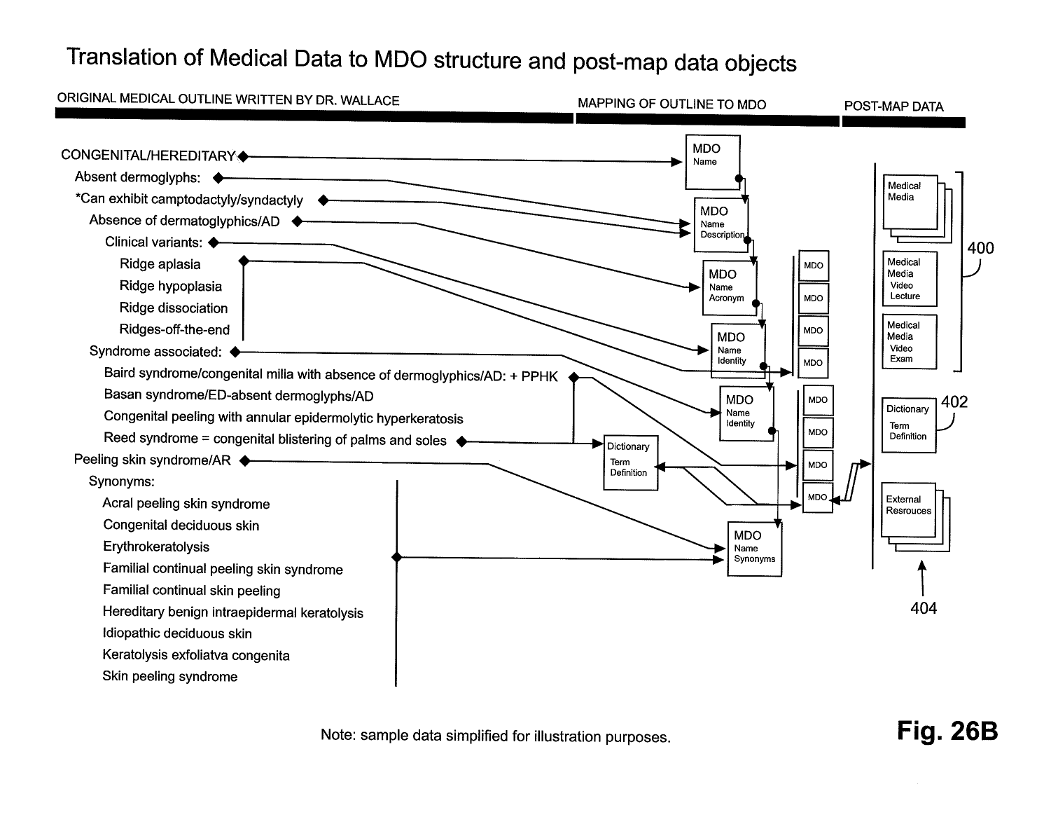

FIGS. 26A and 26B illustrate exemplary database structures for the User Specific Database Table 106 and the Master Database Table 104. As illustrated, the basic structure of the databases 104 and 106 is essentially the same. Both databases are structured with three (3) general categories of fields; Basics, Identity and Relationships.

The Master Database 104, i.e. Medical Data Objects, is under the control of the System Administrator. Two (2) exemplary Data sources are normally used for the Master Database 104. These Data sources include Medical Media 400 and Medical Dictionary 402 External Resources 404 are search links to external resources.

The Medical Media 400 includes Images, video, and info-graphics associated with one or more medical data objects. A Medical Data Object is defined as a basic structural element that captures any single point of related data, for example, as illustrated in FIG. 26B. Other exemplary sources of data for the Master Database Table 104 include a Medical Dictionary 402 and External Resources 404. The Medical Dictionary may be used may be used to over-ride MDO basic data and augment inline MDO description data and user notes. External Resources 404 may be used to provide search links to external resources.

The User Specific Database 106 is similar in structure to the Master Database Table 104. The user specific data base 106 is defined as a user specific derivation of the Medical Data object storing only property derivations. In other words, the user specific database 106 may be used for annotating specific images or adding images to the Master Database 104.

The User Specific Database 106 may be driven by three (3) exemplary data sources: User Media 406; User Dictionary 408; and User Notes 410. The User Media 406 includes user-edited images, video and info-graphics. The User Dictionary 408 is used for augmented fields only for user-edited terms and applicable data. The user notes 410 may be used for attached notes and documents to specific Medical Data Objects. The User resources 412 may be used to provide search links to external resources.

FIG. 26B illustrates an exemplary translation of Medical Data to the Master Database 104. FIG. 26B has three (3) columns. The column on the left is entitled original medical data. The middle column relates to Medical Data Object Translation. The column on the right relates to Augmented Data. The original medical data is mapped to various fields in the Master Data Base 104. As shown various portions of the medical data is mapped to the following fields name, description, synonym and acronym fields under the Basics fields. Other potions are mapped to the Identity fields. As shown in the example, all of the original medical data is augmented by various data, such as Medical Media 400 (FIG. 26A), such as images, video, a lecture Medical dictionary 402 may be used to over-ride certain original medical data. Finally external resources 404 may be used to augment data

### Navigation and Augmentation of Content Tree

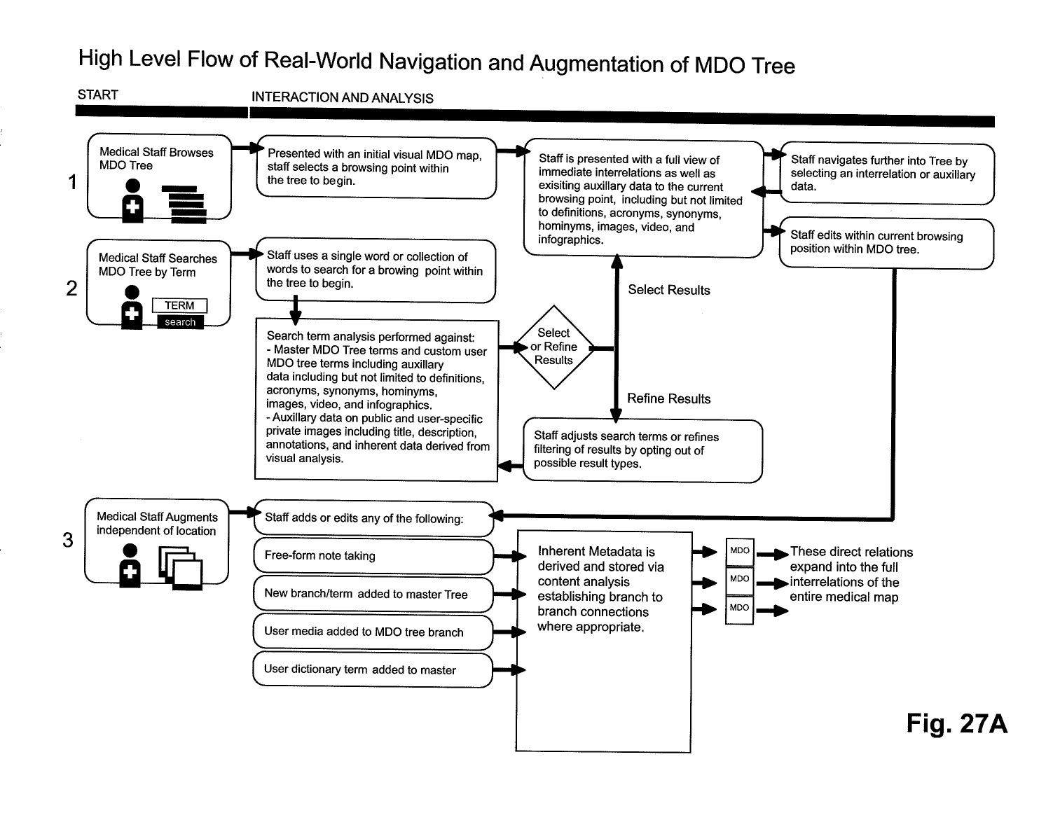

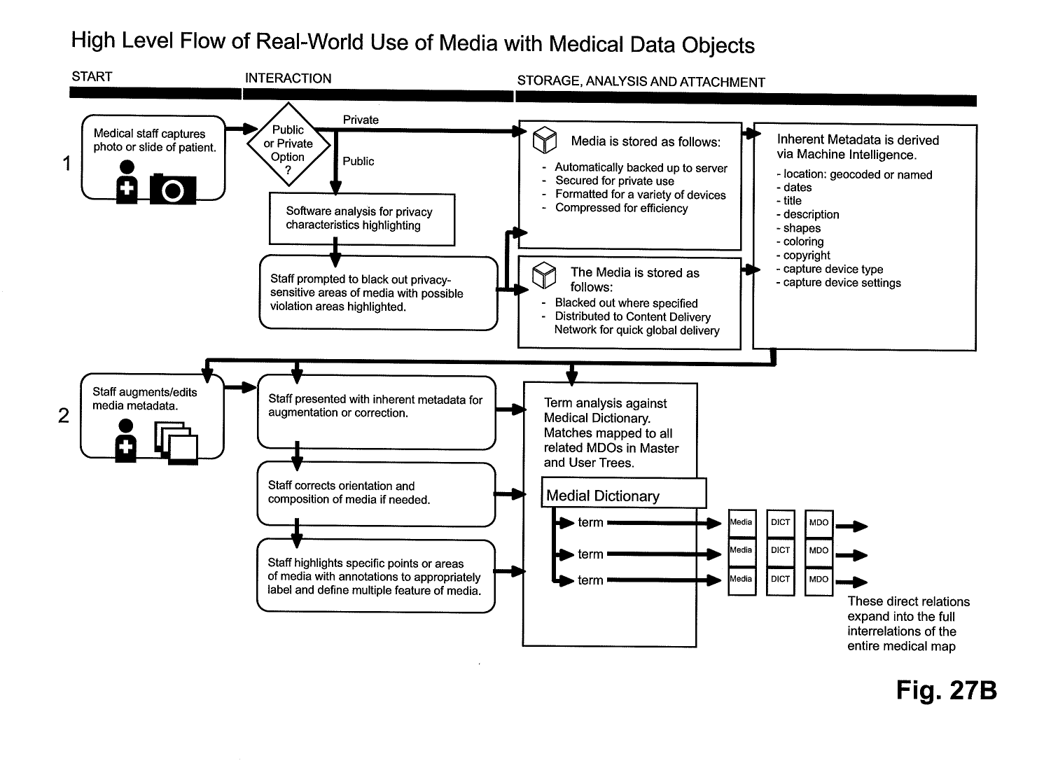

FIG. 27A is a high level diagram illustrating navigation and augmentation of the content tree, i. e. MDO tree. FIG. 27B is a high level diagram illustrating the use of medical media with medical data objects. These figures are self-explanatory and are not discussed further.

### Third Embodiment of the Invention

FIGS. 28-47 illustrate an alternate embodiment of the invention. This embodiment is similar to previous embodiments with a few exceptions. Starting with FIG. 28, an exemplary screen shot is illustrated that comes up after log-in. The web page generally identified with the reference numeral 500 includes a content tree 502, shown collapsed and various exemplary navigation buttons. There are four (4) exemplary navigation buttons identified as “Home”; “Glossary”; “Forums” and “Log-out”. The Home button 504, when selected, returns a user to the page 500, which is the Home page. The Glossary button 506 directs the User to a Glossary page (not shown). The Forums button 508 directs the User to a Forums page (not shown). The Logout button 510 closes the User's connection to the website.

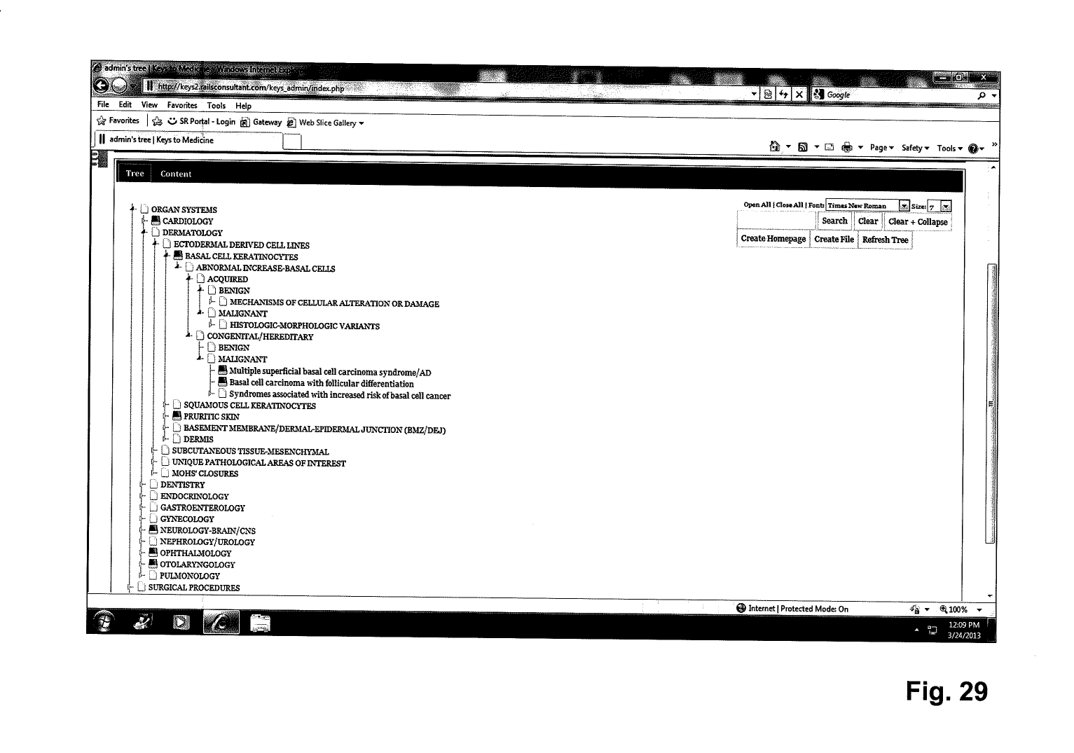

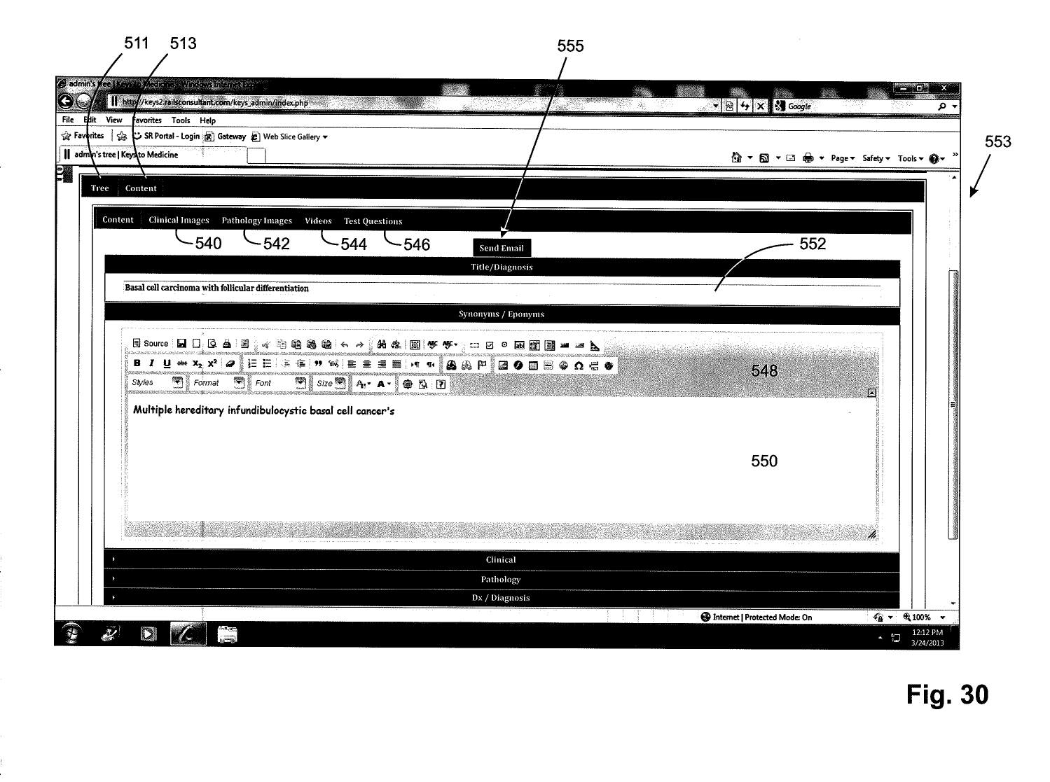

The navigation buttons 511 and 513 control the type of information displayed. For example, the button 511 controls the display of the content tree 502. When depressed, the content tree is displayed, for example as shown in FIG. 29. As shown various lines of the content tree relate to a diagnosis. A diagnosis may be selected by simply highlighting the diagnosis. Once highlighted, the Content button can be selected to provide all of the content associated with a particular diagnosis selected on the content tree. FIGS. 30-33 illustrate exemplary content for an exemplary diagnosis: “Basil cell carcinoma with follicular differentiation.

Once the content button 513 is selected, a plurality of content navigation bars are provided. These exemplary navigation bars may include: Synonym/Eponym bar 570; a Clinical bar 572; a Pathology bar 574 and a Dx/Diagnosis bar 576. Each of these navigation bars brings up a text content page that includes a text box for incorporating text regarding the selected diagnosis. These pages are illustrated in FIGS. 28 and 30-33. As shown, each of the text content pages includes a diagnosis text box 552, which displays the selected diagnosis; a content text box 550; one or more tool bars, 548, for example, Windows® tool bars and may include other tool bars, such as from Adobe's Photo Shop, which can be used to black out portions of an image or text. The tool bars can be used to process, format and edit the data being included on each of the web pages. Finally, an email button 555 is included. The email button allows content to be shared with third parties.

With reference to FIG. 30, an Synonyms/Eponyms page 553 is displayed. This page is displayed whenever the Synonyms/Eponyms bar 570 is selected after a diagnosis is selected. As shown in FIG. 30, the diagnosis displayed is: “Basal carcinoma with follicular differentiation: A content text box 550 is also provided. The text content box 550 relates to Synonyms/Eponyms for the selected diagnosis. In this case, “Multiple hereditary infundibulocystic basal cell cancer's”, is displayed, which falls in the category of Synonym/Eponym for the diagnosis of Basal cell carcinoma with follicular differentiation.

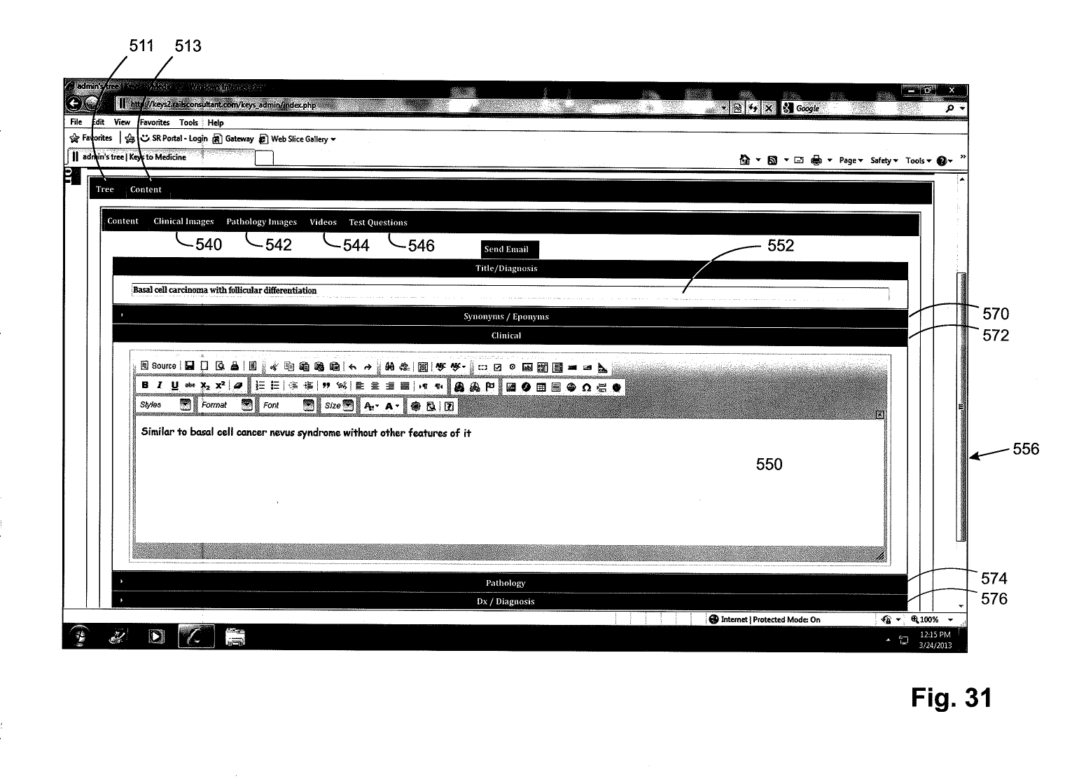

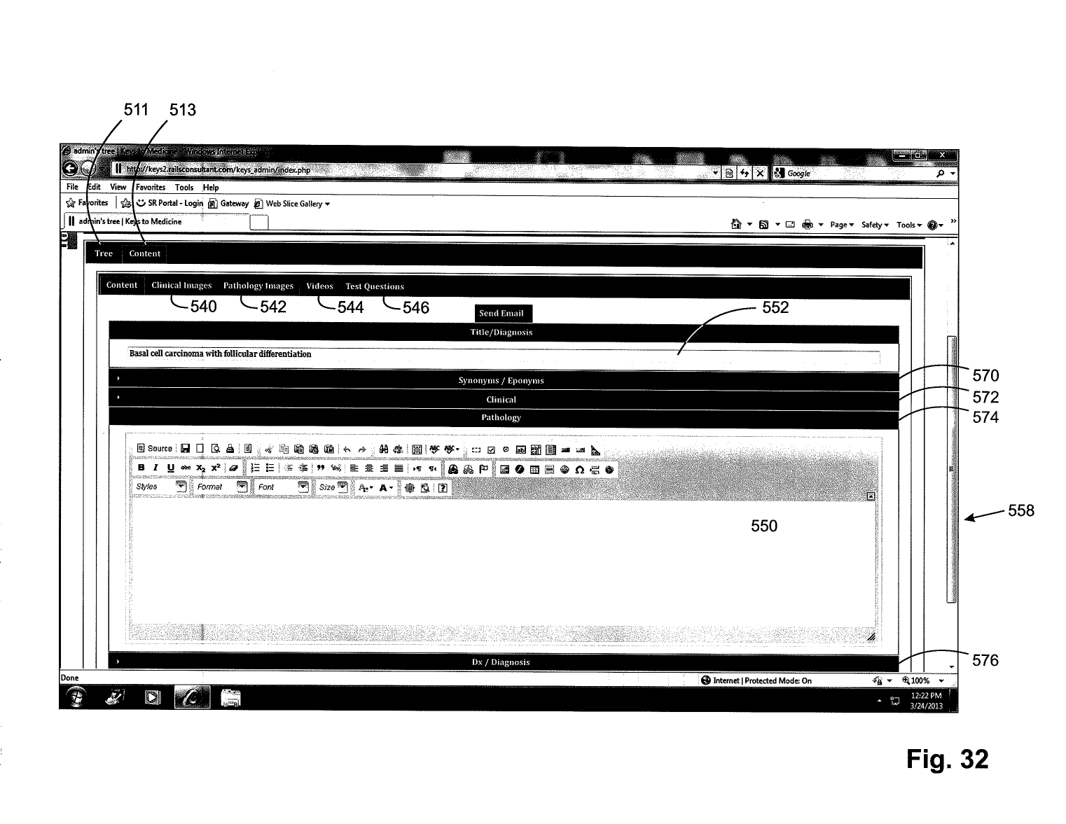

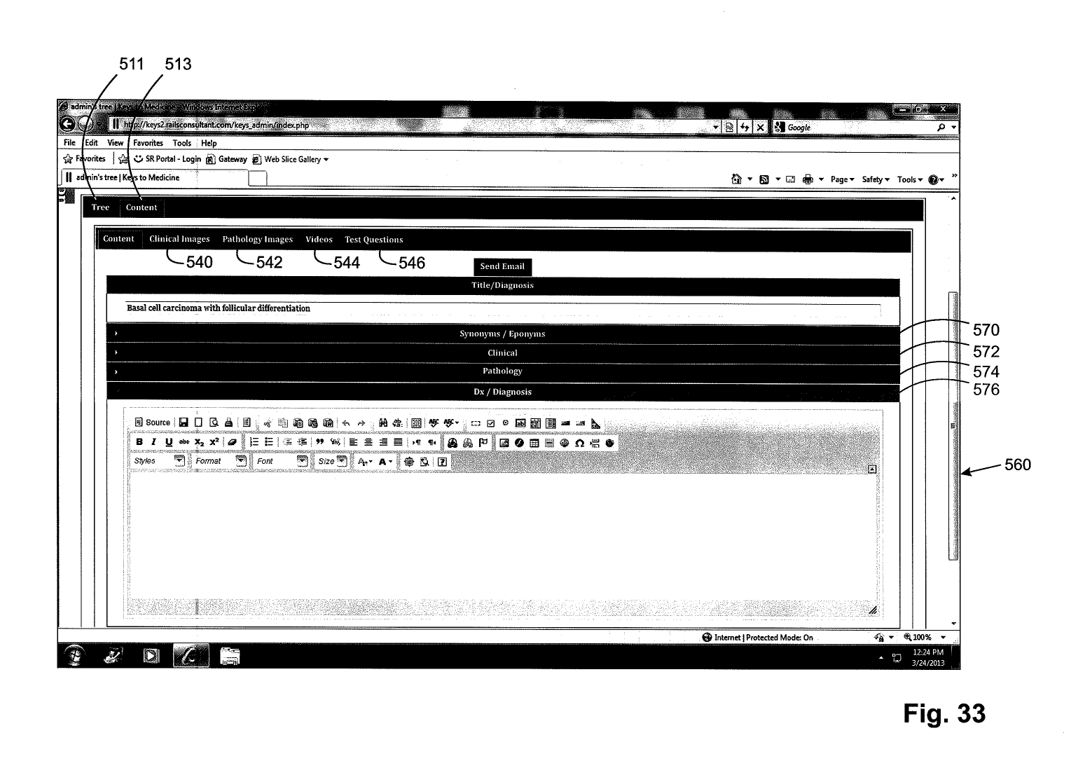

FIG. 31 is similar to FIG. 30 but includes a Clinical page 556 that is selected whenever the Clinical bar 572 is selected. The Clinical page 556 is similar to the Synonyms/Eponyms page but includes Clinical content in the content box 550 for the selected diagnosis in the diagnosis box 552. FIG. 32 is similar to FIG. 30 but relates to a Pathology Page 558 that is selected whenever the Pathology bar 574 is selected. FIG. 33 is similar but relates to a Dx/Diagnosis page 560 that is selected whenever the Dx/Diagnosis bar 576 is selected.

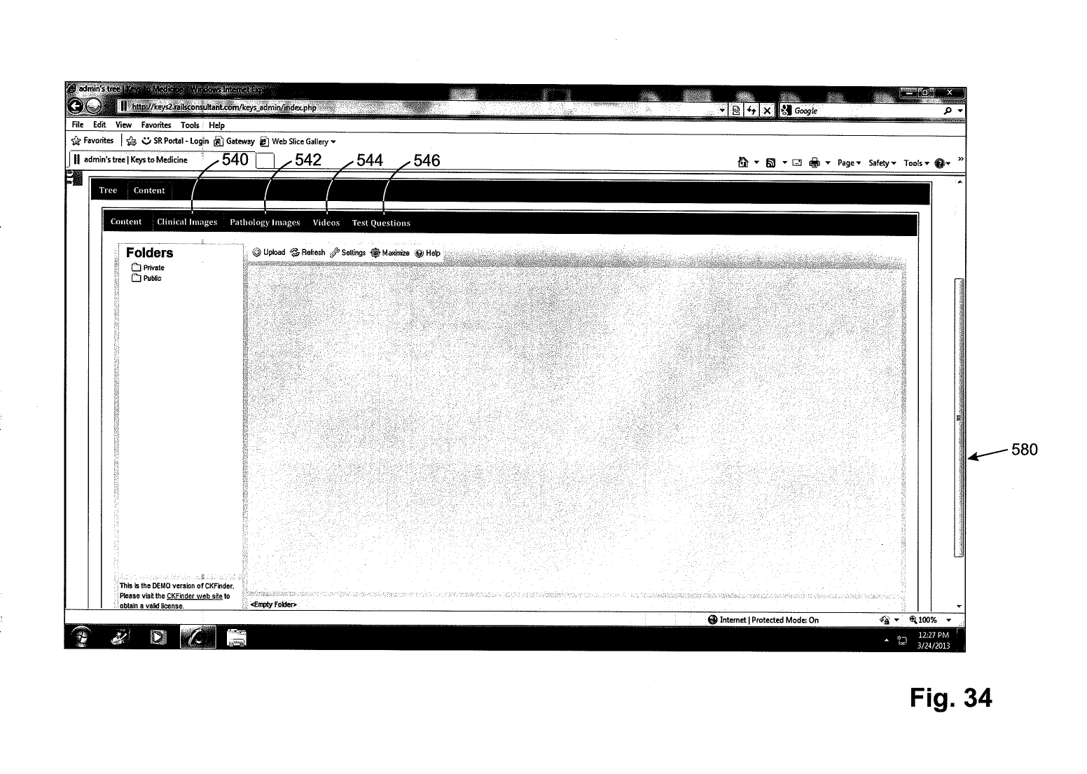

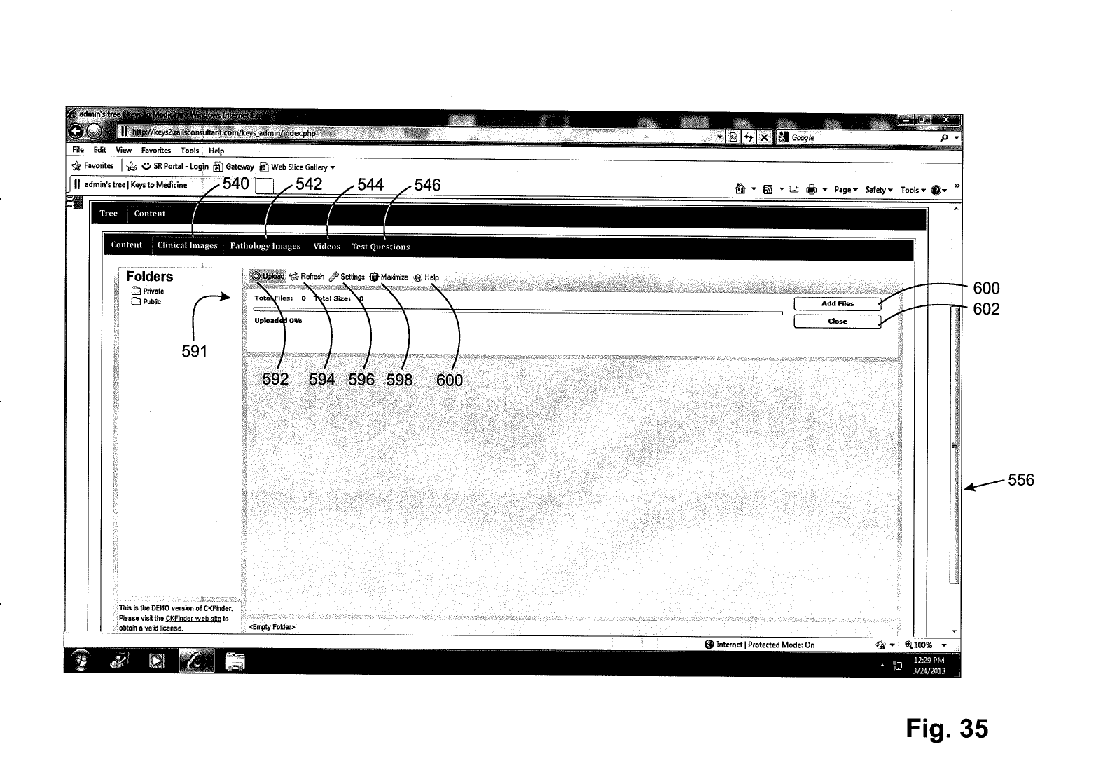

FIGS. 34 and 39-40 illustrate various pages 580, 582, 584 and 586 which are used primarily to illustrate images and video. These pages are under the control of image navigation buttons 540, 542, 544 and 546. These pages 580, 582, 584 and 586 are currently shown blank. FIGS. 35-38, discussed below illustrate how images can be uploaded to these pages 580, 582, 584 and 586.

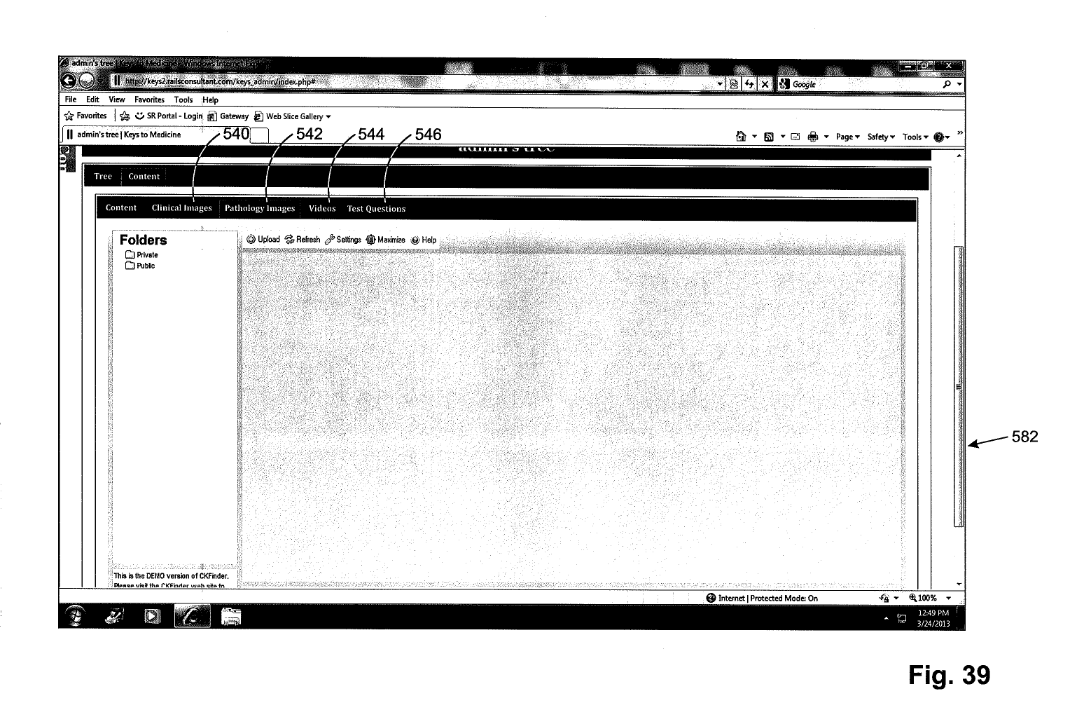

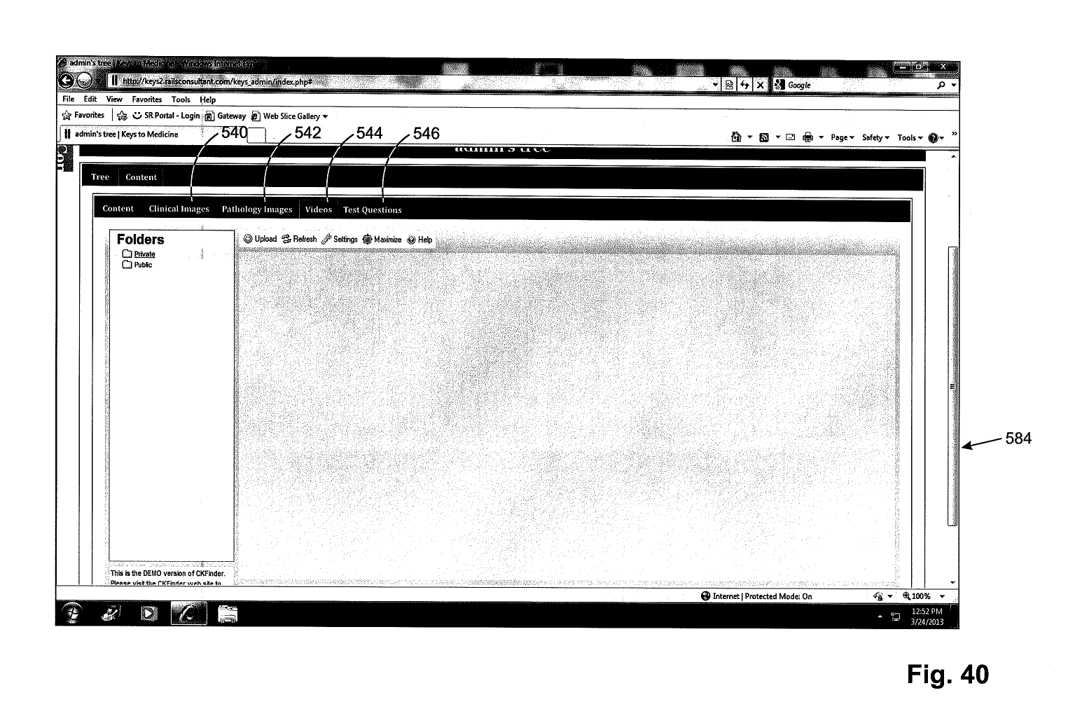

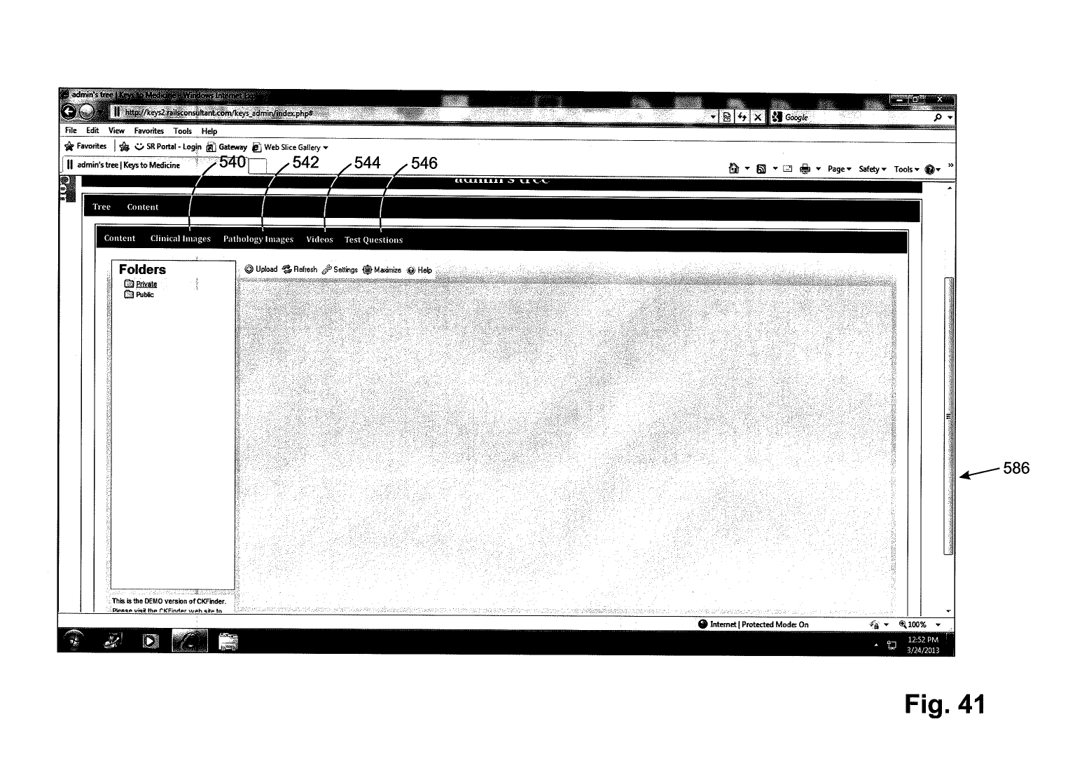

Referring to FIG. 34, this figure relates to clinical images related to the selected diagnosis and is selected when the Clinical Image button 540 is selected. FIG. 39 relates to pathology images related to the selected diagnosis and is selected whenever the Pathology Image button 542 is selected. FIG. 40 relates to videos related to the selected diagnosis. FIG. 41 relates to test questions related to the selected diagnosis and is selected anytime the Test Question button 546 is selected.

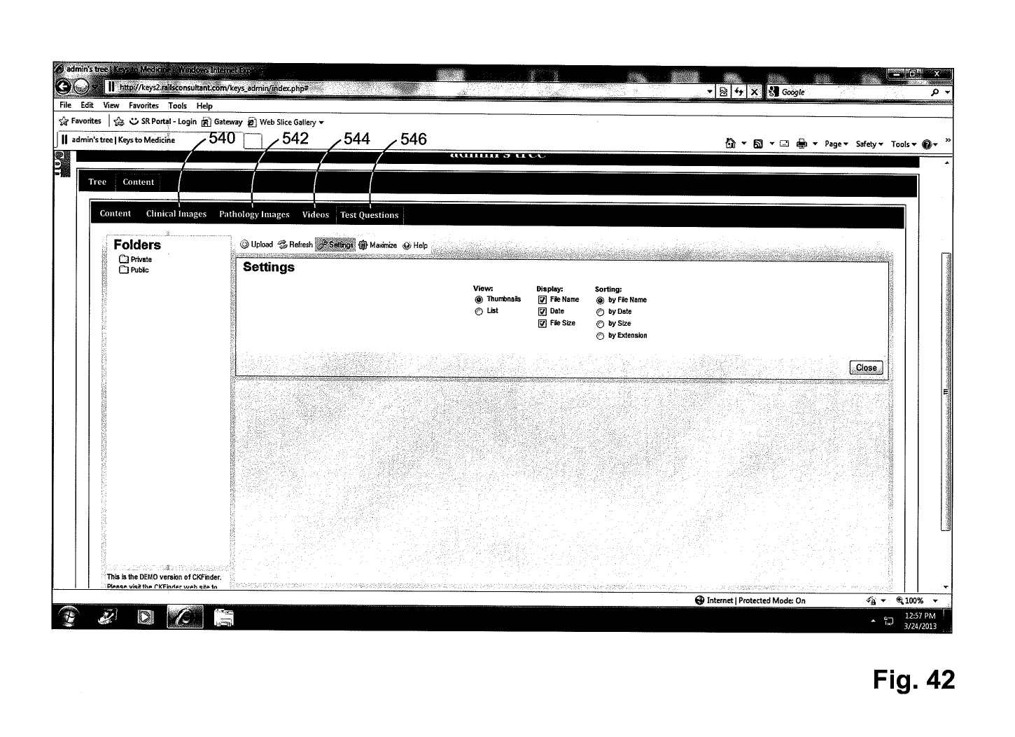

FIGS. 35 and 42 illustrate various features of the web pages 580, 582, 584 and 586. An exemplary Clinical page 556 is illustrated. Each of the pages 580, 582, 584 and 586 includes a tool bar 591 with various control buttons. The tool bar 591 is used to facilitate population of the pages 580, 582, 584 and 586 with various content. The tool bar 591 includes the following buttons: an upload button 592 ; a refresh button, a settings button 596; a maximize button 598 ; and a help button 600. The upload button 592 allows files including image files from the User's hard drive to be uploaded to the page. The refresh button 594 is used to refresh the images that have been loaded. The maximize button 598 maximizes the uploaded image. The help button 600 directs the user to a help page. An Add Files button 600 may be presented when the Upload button 592 is selected. Files may be uploaded by selecting the upload button 592 or the Add files button 600. The various content is uploaded onto the various pages 580, 582, 584 and 586. The settings button 596 when depressed allows all of the data to be added onto the pages to be organized in various ways, as illustrated in FIG. 42. Content can be deleted from the pages 580, 582, 584 and 586 by right clicking on the image or file and selecting DELETE.

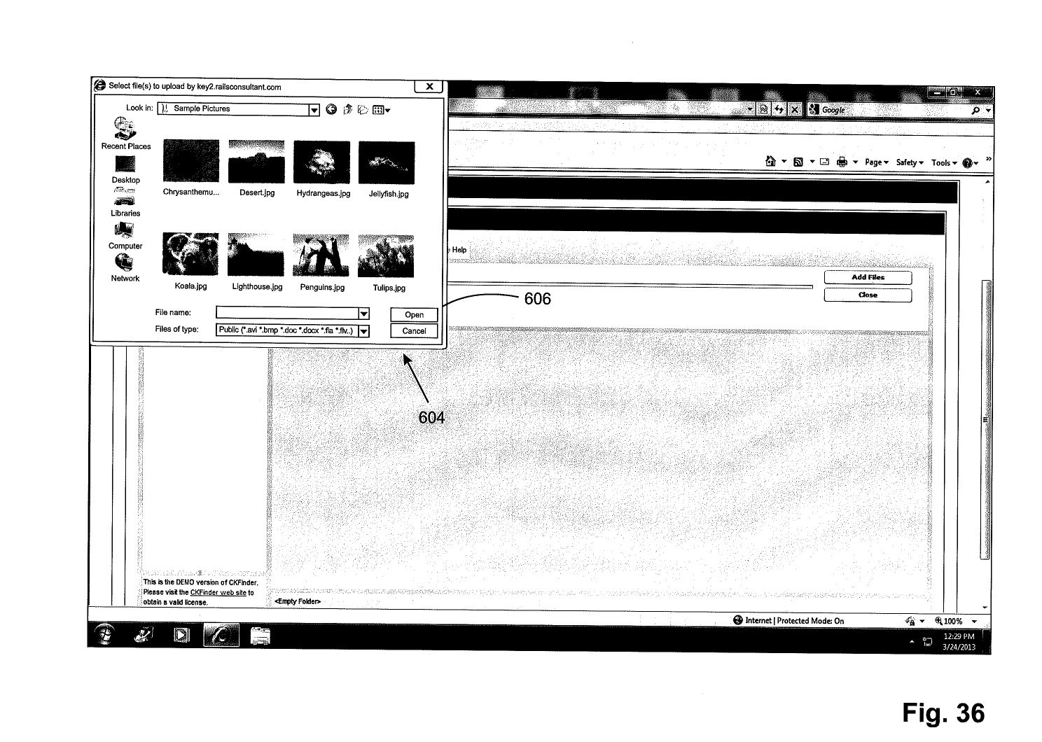

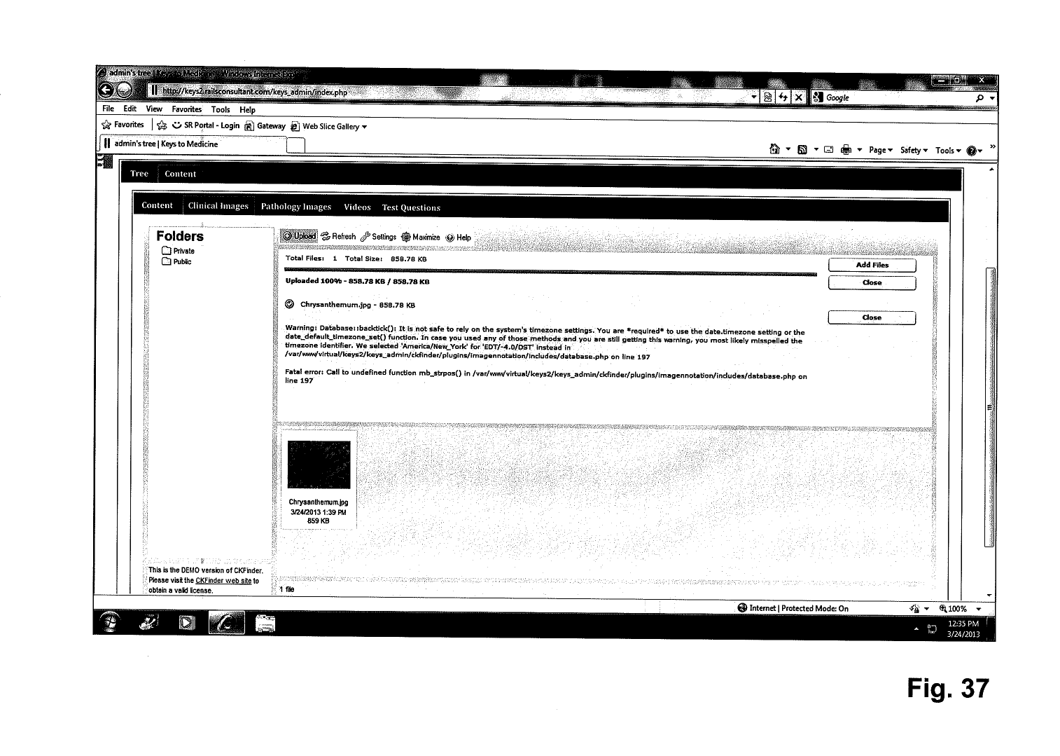

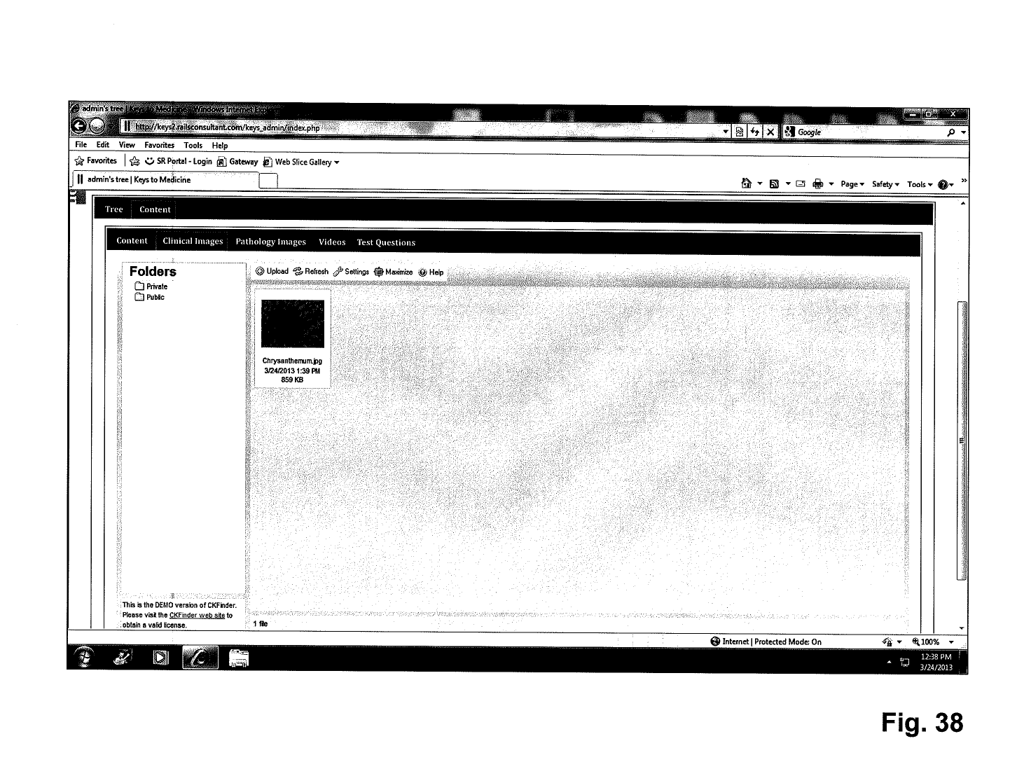

FIGS. 36-38 illustrate the uploading of an image onto one of the pages 580, 582, 584 and 586. FIG. 36 illustrates an exemplary page after the upload 592 has been selected. As shown, various files 604 from the User's hard drive are called up and illustrated. Once a file is highlighted and the open button 606 selected, the file is uploaded onto the page 580, 582, 584 and 586, as illustrated in FIGS. 37 and 38.

Returning to FIG. 28, two (2) methods for searching a diagnosis are provided. One method relates to expanding the content tree and manually searching the diagnosis of interest. A second method relates to typing a diagnosis or partial diagnosis into a search box 522.

The content tree 502 can be expanded by clicking on the various nodes on the content tree or selecting an Open All button 512. Similarly the content tree 502 can be collapsed by selecting a Close all button 514. The font displayed in the content tree can be adjusted by the Font button 516 and a font type drop down menu 518 and a font size drop down menu 520. In order to select a diagnosis, the desired diagnosis is simply highlighted. Once a diagnosis is selected, the various content pages 553, 556, 558, 580, 582, 584 and 586 can be selected to gain more information on the selected diagnosis.

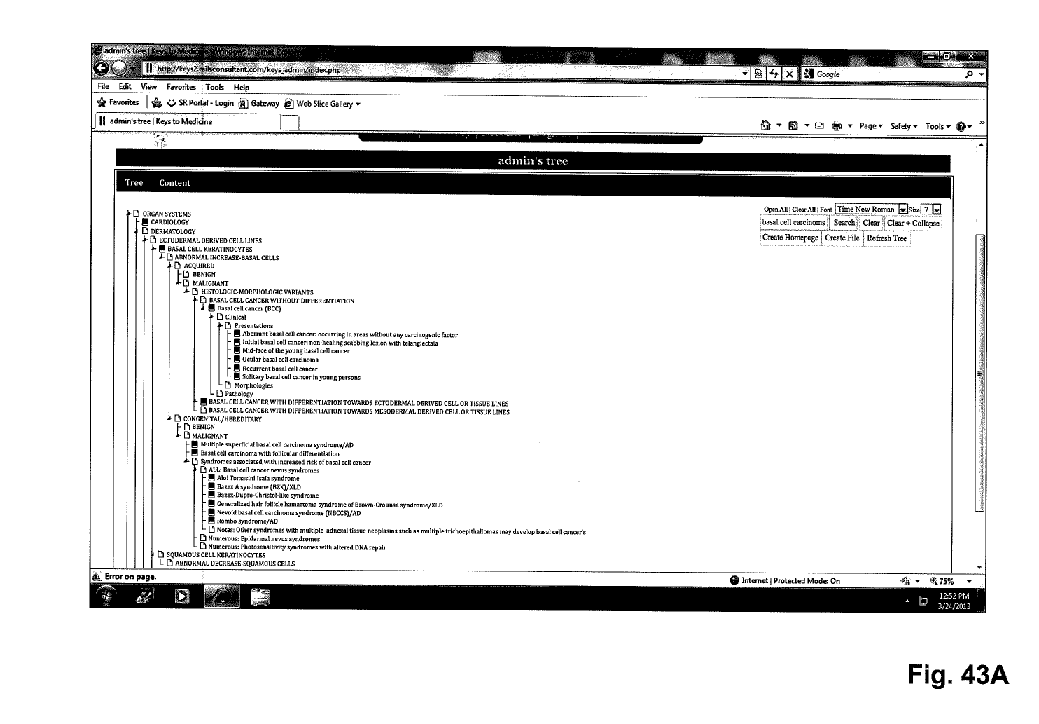

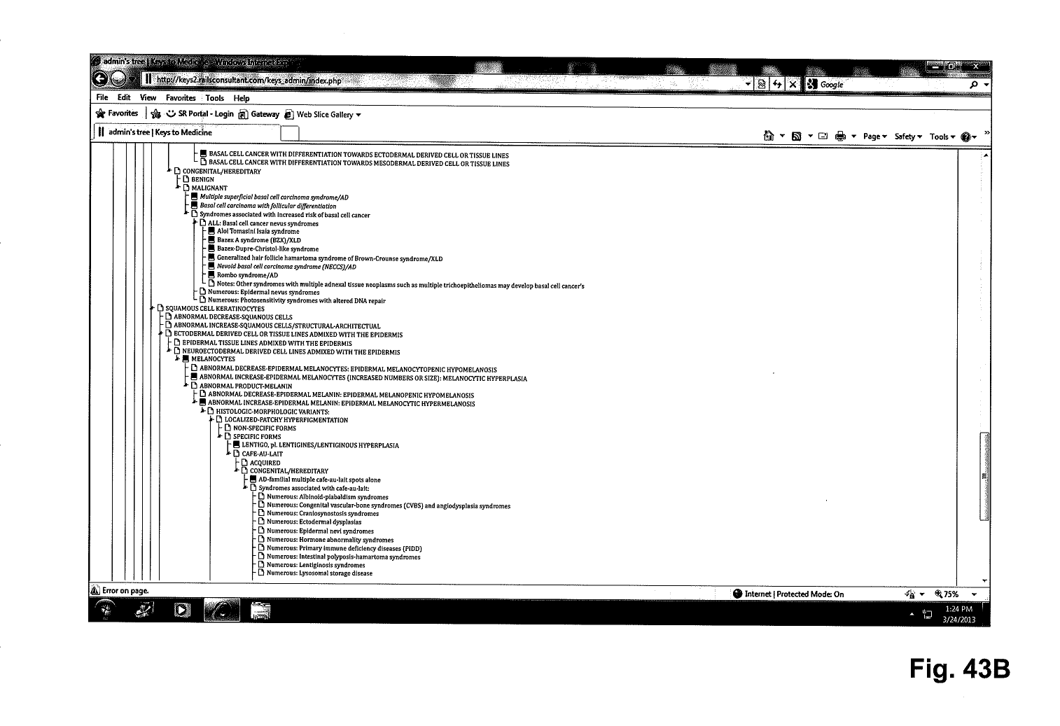

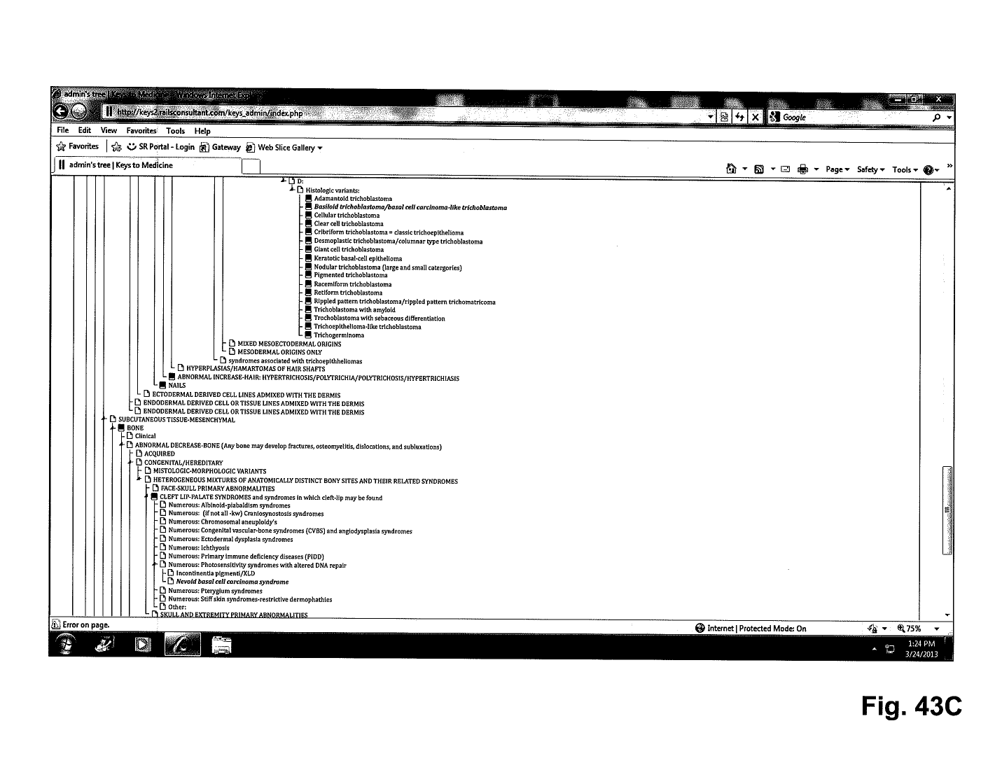

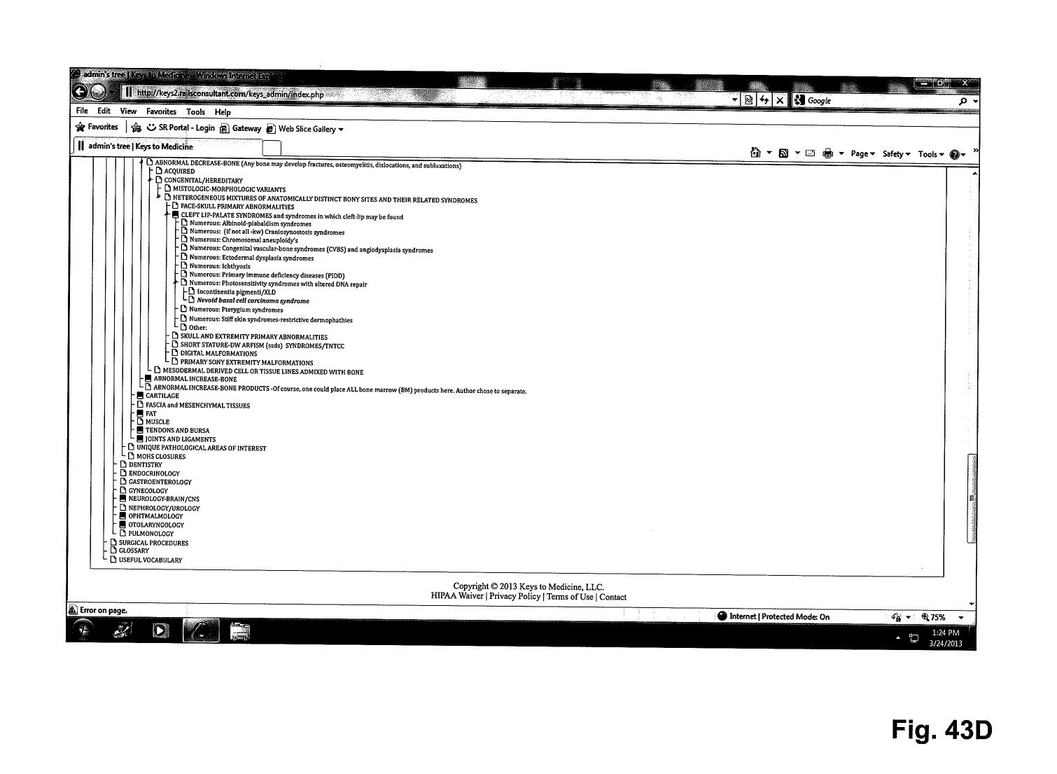

A diagnosis or partial diagnosis may be entered in the search box 522. In this case, the content tree 502 automatically expands and highlights all of the diagnosis that match the search words in the search box 522. This is illustrated in FIGS. 43a-43d. In this case, a diagnosis of basil cell carcinoma was entered in the search box 522. The content tree is expanded and all related diagnoses are highlighted. All related diagnoses are highlighted.

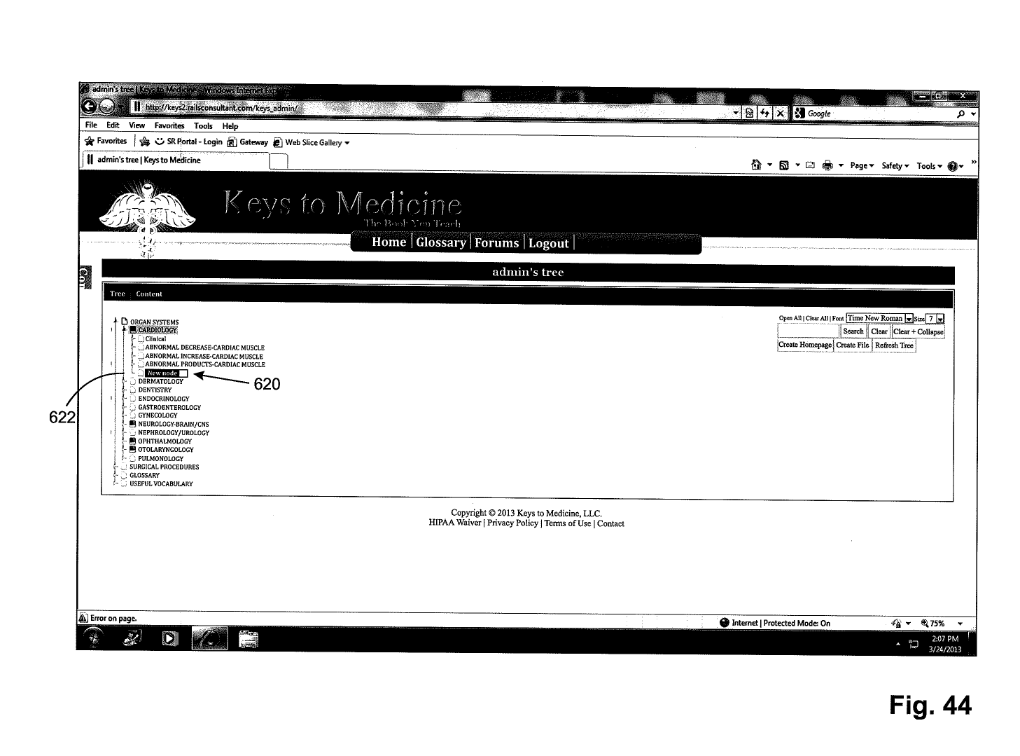

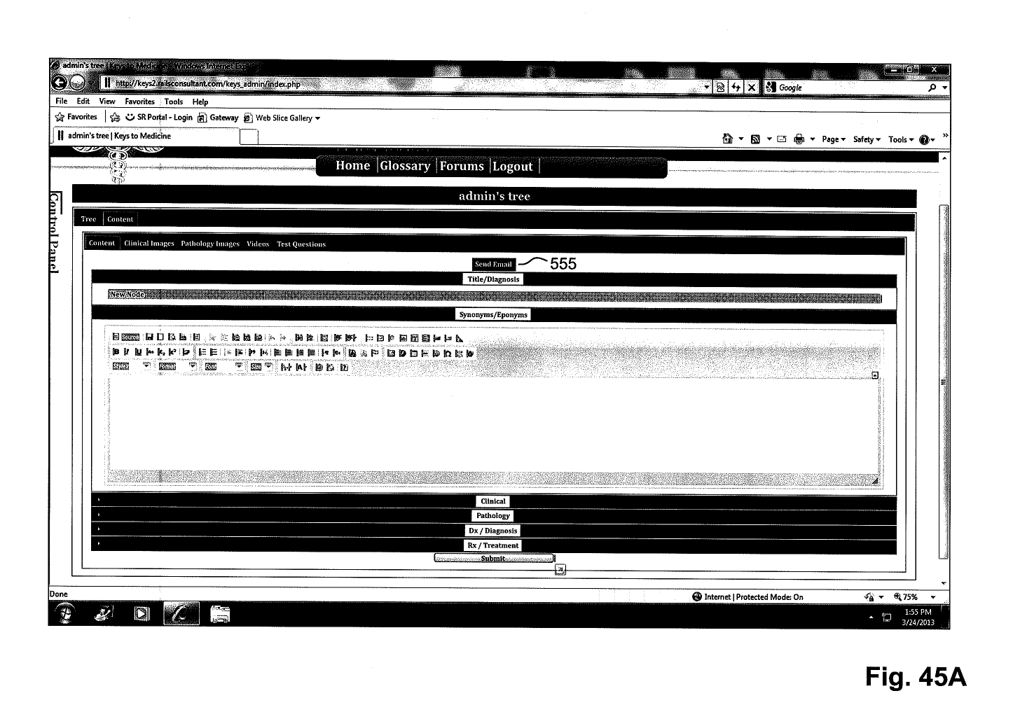

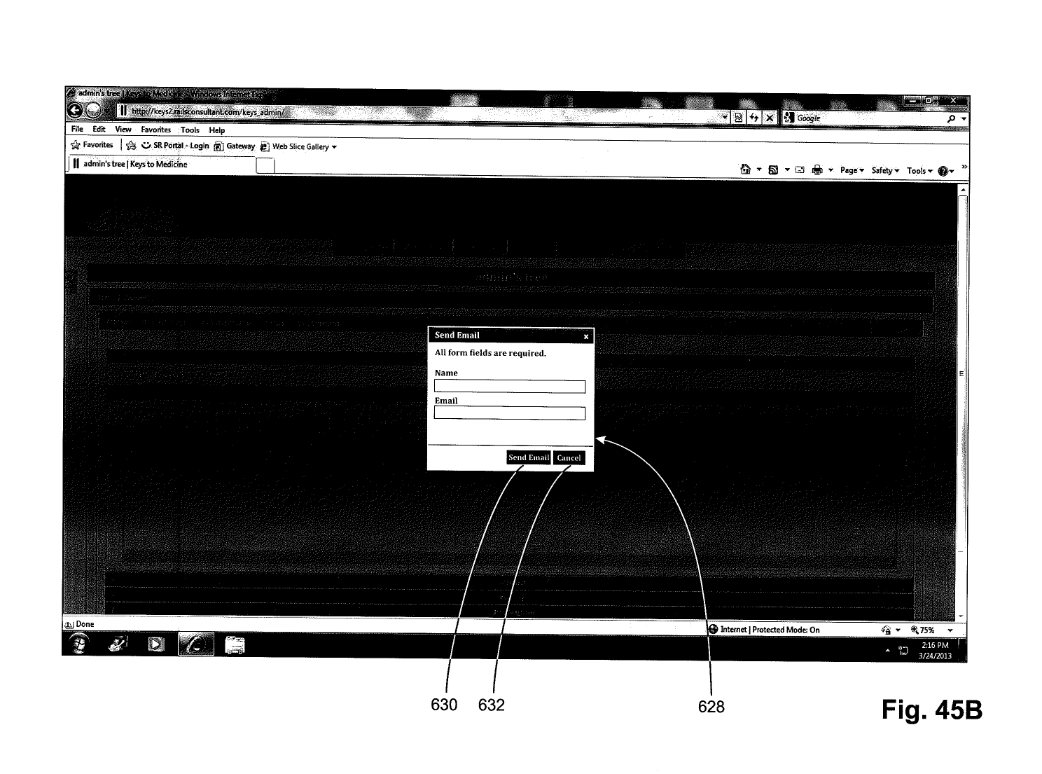

FIGS. 44 and 45 illustrate modifications to the content tree, Referring to FIG. 28, a Create Homepage button 530 allows a new home page 620 (FIG. 44) to be created or a sub-page or file 622 under the newly created home page or an existing page. In order to create a home page or subpage, a page on the content tree is simply highlighted. The Create Home Page button 530 is selected to create a new home page 620 (FIG. 44). Similarly, in order to create a sub-page either under a newly created home page or sub-page, the page is highlighted and the Create File button 536 (FIG. 28) is selected. A Refresh Tree button 534 may then be selected to refresh the content tree.

FIGS. 45A and 45 B illustrate a feature of the invention that allows content to be shared with third parties. Specifically, the various content pages 553, 556, 558, 580, 582, 584 and 586 may include a Send Email button 555 (FIGS. 30 and 45A). When this button 624 is selected, a dialog box 628 pops up which enables a recipient's name and email address to be inserted. Once inserted, a Send Email button is selected to send the email to the desired recipient. Alternatively, a Cancel button 632 is provided that allows the Email to be cancelled.

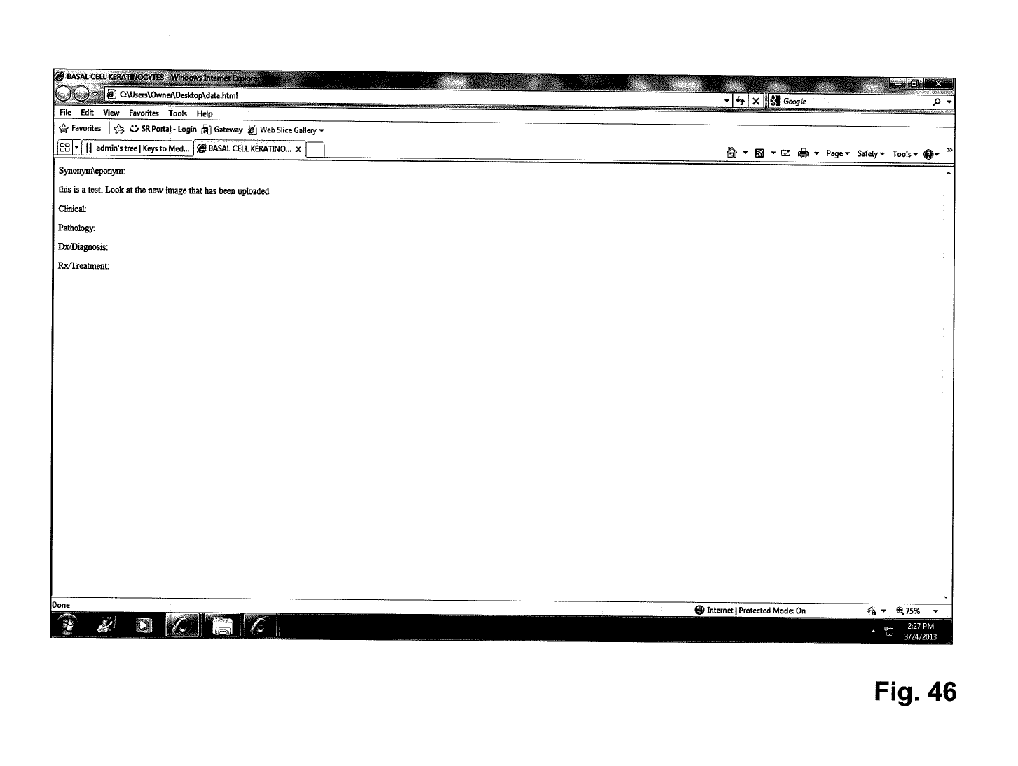

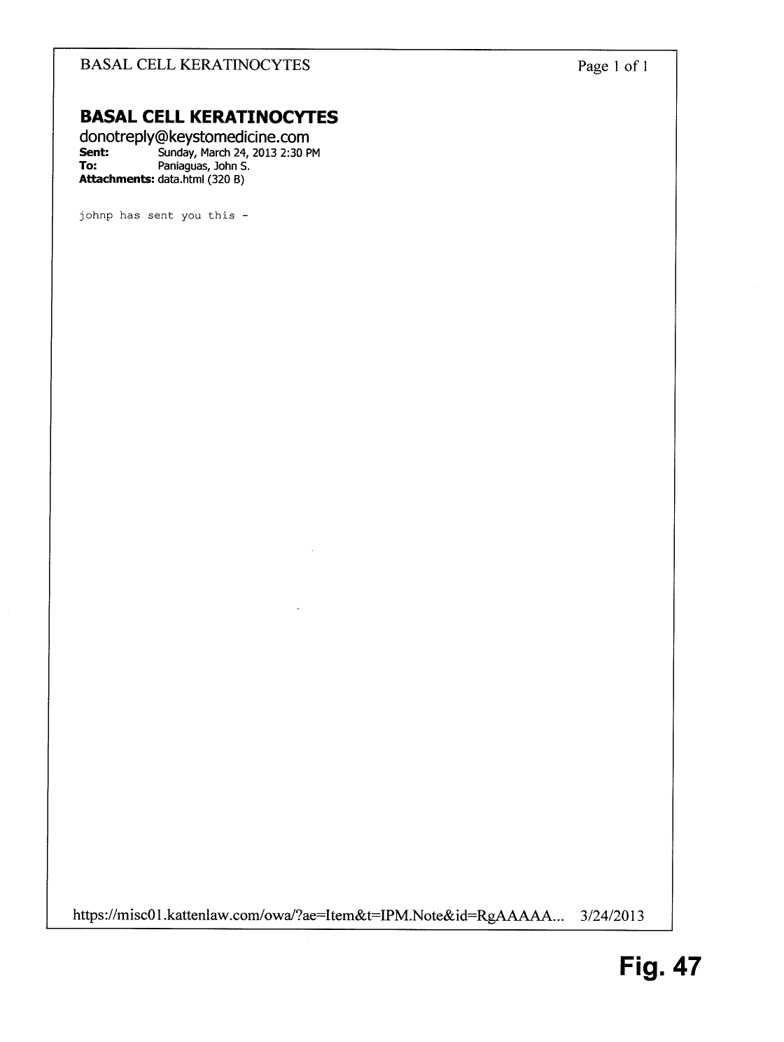

An exemplary Synonym/Eponym page with comments to be shared is illustrated in FIG. 46. FIG. 47 illustrates an email that was received by the recipient. The comments illustrated in FIG. 46 are attached as an attachment as indicated by “data.html(329 B). The recipient email also identifies the sender. Specifically, the email contains a note: “johnp has sent you this.”

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A user configurable on-line textbook comprising:
an electronic textbook accessible over the Internet;
an electronic template broken down into various subject matter corresponding to the subject matter of said electronic textbook, said template accessible over the Internet; and
at least one associated database accessible over the Internet which allows said electronic textbook to be personalized by one or more individual users by enabling personalized images to be uploaded and associated with a particular subject matter by each of said one or more individual users.
